(19) United States
(12) Patent Application Publication
(10) Pub. No.: US 2026/0350111 A1
(43) Pub. Date: Nov. 5, 2026

(54) NEUROMORPHIC METHOD TO SOLVE QUADRATIC UNCONSTRAINED BINARY OPTIMIZATION (QUBO) PROBLEMS

(71) Applicant: Telefonaktiebolaget LM Ericsson (publ), Stockholm (SE)

(72) Inventor: Ahsan Javed AWAN, Vallentuna (SE)

(73) Assignee: Telefonaktiebolaget LM Ericsson (publ), Stockholm (SE)

(21) Appl. No.: 19/117,023

(22) PCT Filed: Oct. 18, 2022
(86) PCT No.: PCT/IB2022/060021

§ 371 Date: Mar. 28, 2025

(51) Int. Cl. G06F 17/11; G06F 17/16; G06N 3/044; G06N 3/063

(52) U.S. Cl. CPC G06F 17/11; G06F 17/16; G06N 3/044; G06N 3/063

(57) ABSTRACT

A method is performed by an electronic device for solving a quadratic unconstrained binary optimization (QUBO) problem. The method comprises implementing a plurality of neurons, each neuron representing a respective binary decision variable of the QUBO problem, each neuron connected to one or both of a respective excitatory noise source and a respective inhibitory noise source. The method further comprises implementing a first plurality of synapses as a plurality of recurrent synapses, each recurrent synapse connected to a respective neuron of the plurality of neurons, each recurrent synapse having a respective weight corresponding to a diagonal coefficient of a QUBO matrix. The method further comprises implementing a second plurality of synapses as a plurality of lateral synapses extending between pairs of neurons of the plurality of neurons, each lateral synapse having a respective weight corresponding to an off-diagonal coefficient of the QUBO matrix.

### TECHNICAL FIELD

Embodiments of the invention relate to the field of neuromorphic computing; and more specifically, the application of neuromorphic computing techniques to solve quadratic unconstrained binary optimization (QUBO) problems.

### BACKGROUND ART

Cellular telecommunication networks, sometimes referred to herein as “mobile networks,” are relatively large networks encompassing a large number of electronic devices to enable other electronic devices (sometimes referred to as “user equipment” (UE) or “mobile devices”) to connect wirelessly to the mobile network. The mobile network is also typically connected to one or more other networks (e.g., the Internet). The mobile network enables the electronic devices currently connected to the mobile network to communicate over the network(s) with other electronic devices. The mobile network is designed to allow the mobile devices, e.g., mobile phones, tablets, laptops, IoT devices and similar devices, to shift connection points with the mobile network in a manner that maintains continuous connections for the applications of the mobile devices. Typically, the mobile devices connect to the mobile network via radio access network (RAN) base stations (sometimes referred to as “access points”), which provide connectivity to a number of mobile devices for a local area or “cell”. Managing and configuring the mobile network including the cells of the mobile network is an administrative challenge as each cell can have different geographic and/or technological characteristics.

Due to the complexity and the dynamic nature of mobile networks, various optimization calculations may be performed to configure the mobile network (and/or electronic devices encompassed by the mobile network) for improved operation. Some examples of optimization problems associated with a mobile network include provisioning resources to efficiently support a set of virtual network functions of the mobile network, offloading computing from mobile devices onto resources of the mobile network, allocating mobile devices between macro cells and micro cells of the mobile network to improve throughput and/or quality of service, allocating channels among RAN base stations of the mobile network, multiple-input multiple-output (MIMO) signal detection for electronic devices of the mobile network, and so forth.

In some cases, there are no known efficient algorithms for performing a particular optimization calculation using current techniques. Current techniques for finding an optimized solution generally rely on heuristic algorithms but may be suboptimal and/or slow, which causes the mobile network to consume excess energy and is not suitable for a dynamic environment (e.g., where mobile devices are expected to move regularly through the coverage areas of different RAN base stations). While quantum techniques can accelerate the time to reaching a solution, such an approach remains energy expensive. Further, the inadequacy of the current techniques may become more pronounced with the continued development of mobile networks, as increasing the complexity of the mobile network tends to also increase the relative complexity of the optimization calculation.

### SUMMARY

In one embodiment, a method is performed by an electronic device for solving a quadratic unconstrained binary optimization (QUBO) problem. The method comprises implementing a plurality of neurons, each neuron representing a respective binary decision variable of the QUBO problem, each neuron connected to one or both of a respective excitatory noise source and a respective inhibitory noise source. The method further comprises implementing a first plurality of synapses as a plurality of recurrent synapses, each recurrent synapse connected to a respective neuron of the plurality of neurons, each recurrent synapse having a respective weight corresponding to a diagonal coefficient of a QUBO matrix. The method further comprises implementing a second plurality of synapses as a plurality of lateral synapses extending between pairs of neurons of the plurality of neurons, each lateral synapse having a respective weight corresponding to an off-diagonal coefficient of the QUBO matrix.

In one embodiment, an electronic device is provided that comprises a machine-readable medium comprising computer program code for a quadratic unconstrained binary optimization (QUBO) problem solver service to solve a QUBO problem. The electronic device further comprises one or more processors to execute the QUBO problem solver service to cause the electronic device to implement a plurality of neurons, each neuron representing a respective binary decision variable of the QUBO problem. The electronic device further implements a plurality of excitatory noise sources, each neuron connected to a respective excitatory noise source. The electronic device further implements a first plurality of synapses as a plurality of recurrent synapses, each recurrent synapse connected to a respective neuron of the plurality of neurons, each recurrent synapse having a respective weight corresponding to a diagonal coefficient of a QUBO matrix. The electronic device further comprises a second plurality of synapses as a plurality of lateral synapses extending between pairs of neurons of the plurality of neurons, each lateral synapse having a respective weight corresponding to an off-diagonal coefficient of the QUBO matrix.

### BRIEF DESCRIPTION OF THE DRAWINGS

The invention may best be understood by referring to the following description and accompanying drawings that are used to illustrate embodiments of the invention. In the drawings:

FIG. 1 illustrates a method performed by an electronic device for solving an exemplary quadratic unconstrained binary optimization (QUBO) problem for multiple-input multiple-output (MIMO) signal detection, according to one or more embodiments.

FIG. 2 is a diagram illustrating communication between MIMO-capable communication devices, according to one or more embodiments.

FIG. 3 is a diagram illustrating a neural network with neurons representing binary decision variables of an exemplary QUBO problem for MIMO signal detection, according to one or more embodiments.

FIG. 4 is a diagram illustrating an exemplary implementation of a neural network with recurrent synapses and lateral synapses having weights corresponding to values of a QUBO matrix, according to one or more embodiments.

FIG. 5 is a diagram illustrating exemplary neuromorphic hardware, according to one or more embodiments.

FIG. 6A illustrates connectivity between network devices (NDs) within an exemplary network, as well as three exemplary implementations of the NDs, according to some embodiments of the invention.

FIG. 6B illustrates an exemplary way to implement a special-purpose network device according to some embodiments of the invention.

FIG. 6C illustrates various exemplary ways in which virtual network elements (VNEs) may be coupled according to some embodiments of the invention.

FIG. 6D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 6E illustrates the simple case of where each of the NDs implements a single NE, but a centralized control plane has abstracted multiple of the NEs in different NDs into (to represent) a single NE in one of the virtual network(s), according to some embodiments of the invention.

FIG. 6F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 7 illustrates a general purpose control plane device with centralized control plane (CCP) software, according to some embodiments of the invention.

FIG. 8 illustrates an exemplary application of the neural network-based implementations to an example cell allocation for a mobile network, according to one or more embodiments.

FIG. 9 illustrates an exemplary application of the neural network-based implementations to an example channel allocation for a mobile network, according to one or more embodiments.

FIGS. 10A-10F illustrate operation of a neural network using sets of tuning parameters, according to one or more embodiments.

### DETAILED DESCRIPTION

The following description describes methods and apparatus for solving quadratic unconstrained binary optimization (QUBO) problems for mobile networks and/or mobile devices using neural network-based implementations, such as multiple-input multiple-output (MIMO) signal detection. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Techniques described herein are directed to neural network-based implementations for solving QUBO problems for mobile networks and/or mobile devices (such as MIMO signal detection) in a rapid and/or energy-efficient matter. The techniques may be extended to numerous other applications capable of being modeled as QUBO problems. In some embodiments, the binary decision variables of a QUBO problem are mapped to neurons of the neural network, each of which are connected to excitatory noise sources and/or inhibitory noise sources. A recurrent synapse is formed for each of the neurons using diagonal entries of the QUBO matrix, and lateral synapses are formed that connect different neurons using off-diagonal entries of the QUBO matrix.

The neural network-based implementations described herein provide several advantages over existing solutions such as heuristic algorithms. The implementations are efficient in terms of neurons and synapses, using a number of neurons equal to the total number of decision variables of the QUBO problem, and a number of synaptic connections equal to the number of non-zero entries in the QUBO matrix. Thus, given the relatively low resource requirement, the neural network-based implementations may be scaled to solve QUBO problems of any size. Further, the approximations generated by the neural network-based implementations yield a “good-enough” solution for the QUBO problem relatively rapidly, and are therefore suitable for use in a dynamic setting. In some cases, the neural network-based implementations can be implemented using neuromorphic hardware deployed at the edge of telecommunications infrastructure.

The neural network-based implementations can provide two-fold energy efficiency improvements over existing solutions such as heuristic algorithms. First, use of the neural network-based implementations allows the solutions to be more quickly approximated, and the solutions may also be closer to optimal than solutions generated using heuristic algorithms. Reaching solutions more quickly tends to reduce the energy expense associated with determining the solutions, and the more optimized solutions generally provide a greater utilization of associated electronic devices (e.g., devices operated as infrastructure of a mobile network) to support a given set of mobile devices, which reduces the energy expense of implementing the solution. Second, some embodiments use neuromorphic hardware to implement the neural network-based implementations. The neuromorphic hardware is substantially more energy efficient than conventional processor architectures, generally through massive parallelism, co-location of processing and memory at the neurons and synapses, inherent scalability, temporally sparse event-driven computation, and stochasticity.

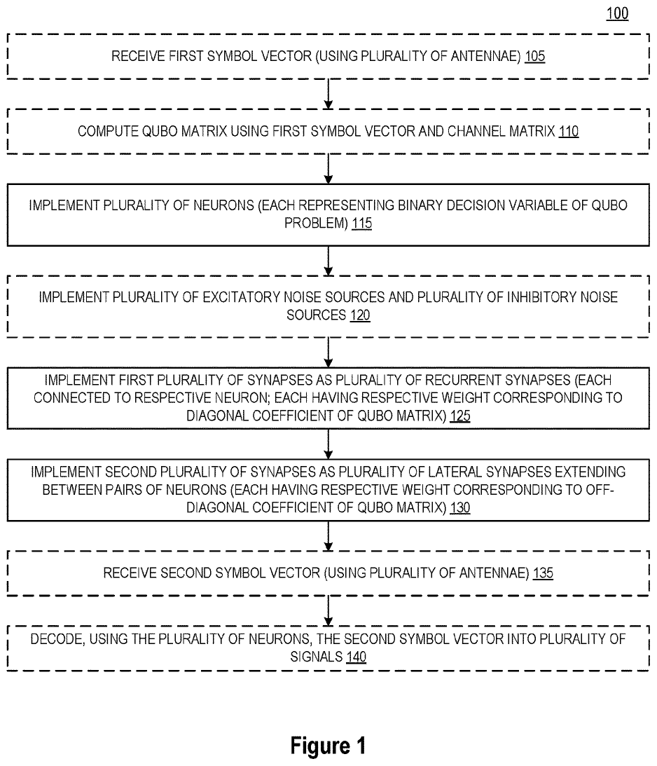

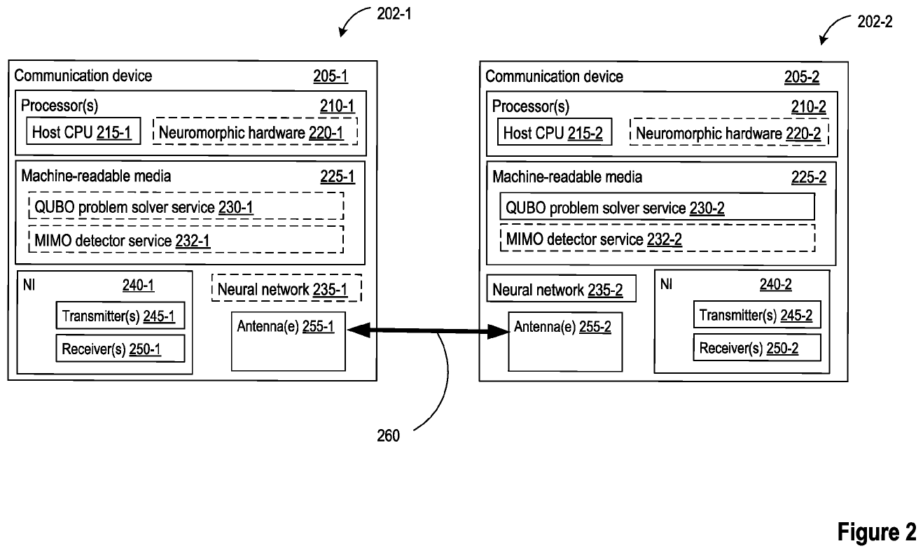

FIG. 1 illustrates a method 100 performed by an electronic device for solving a quadratic unconstrained binary optimization (QUBO) problem, according to one or more embodiments. The method 100 may be used in conjunction with other embodiments, e.g., performed by a neural network 235-1, 235-2 (collectively or generically, neural network(s) 235) implemented using hardware and/or software of an electronic device 202-1, 202-2 (collectively or generically, electronic device(s) 202) shown in diagram 200 of FIG. 2. Thus, while various blocks of the method 100 are described as being performed by the neural network 235, the blocks (or portions thereof) will be understood as being implemented using software executing on hardware (and in some embodiments, in conjunction with specialized hardware such as neuromorphic hardware 220-1, 220-2 (collectively or generically, neuromorphic hardware 220) of the electronic device 202. Further, terms such as “inhibitory signals” and “excitatory signals” will be understood to encompass physical signals that are transmitted using machine-readable transmission media (e.g., wireline electrical signals, wireless signals, optical signals), as well as signals that are simulated in software (e.g., time-based changes in memory states).

The method 100 is capable of determining a solution to a QUBO problem, and is described specifically within the exemplary context of multiple-input multiple-output (MIMO) signal detection. However, other types of optimization problems for a mobile network (or for electronic devices encompassed by the mobile network), suitable for being framed as a QUBO problem, are also contemplated. In some embodiments, the solution to the QUBO problem is used in conjunction with the configuration of the mobile network by the electronic device 202.

As used herein, an electronic device 202 stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors each having one or more processor cores (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radio frequency communication. The radio circuitry may convert digital data into a radio signal having the appropriate parameters (e.g., frequency, timing, channel, bandwidth, etc.). The radio signal may then be transmitted via antenna (e) to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

In some embodiments, and as shown, the electronic devices 202-1, 202-2 are implemented as respective communication devices 205-1, 205-2 (collectively or generically, communication device(s) 205). As used herein, a communication device 205 may be any electronic device intended for accessing services via an access network (e.g., a mobile network) and configured to communicate over the access network. For instance, the communication device 205 may be, but is not limited to: mobile phone, smart phone, sensor device, meter, vehicle, household appliance, medical appliance, media player, camera, or any type of consumer electronics, for instance, but not limited to, television, radio, lighting arrangement (e.g., a digital billboard, a video wall or other large screen video display, or commercial or residential smart lighting devices), tablet computer, laptop, or PC. The communication device 205 may be a portable, pocket-storable, hand-held, computer-comprised (e.g., a laptop, desktop, or rack-mounted computer), or vehicle-mounted mobile device, enabled to communicate voice and/or data, via a wireless or wireline connection. In other embodiments, one or both of the electronic devices 202-1, 202-2 are implemented as network equipment of the access network (e.g., providing one or more physical and/or virtual network functions to the access network).

The communication devices 205-1, 205-2 may include a number of components. The diagram 200 illustrates each of the communication devices 205-1, 205-2 as comprising one or more processors 210-1, 210-2 and machine-readable media 225-1, 225-2 for simplicity. While depicted as a single element within the communication devices 205-1, 205-2, the one or more processors 210-1, 210-2 contemplates a single processor, multiple processors, a processor or processors having multiple cores, as well as combinations thereof. In one embodiment, the one or more processors 210-1, 210-2 comprises a host central processing unit (CPU) 215-1, 215-2 of the communication devices 205-1, 205-2.

As previously described, machine-readable media, such as the machine-readable media 225-1, 225-2, may include a variety of media selected for relative performance or other capabilities: volatile and/or non-volatile media, removable and/or non-removable media, etc. Thus, the machine-readable media 225-1, 225-2 may include cache, random access memory (RAM), storage, etc. Storage included in the machine-readable media 225-1, 225-2 typically provides a non-volatile memory for the communication devices 205-1, 205-2, and may include one or more different storage elements such as Flash memory, a hard disk drive, a solid-state drive, an optical storage device, and/or a magnetic storage device.

The communication devices 205-1, 205-2 further comprise NIs 240-1, 240-2, each comprising one or more transmitters 245-1, 245-2 and one or more receivers 250-1, 250-2. The communication devices 205-1, 205-2 further comprise one or more antennae 255-1, 255-2 that are connected to the transmitter(s) 245-1, 245-2 and to the receiver(s) 250-1, 250-2. The antenna (e) 255-1, 255-2 may have any suitable implementation for communicating radio frequency signals between the communication devices 205-1, 205-2.

In some embodiments, the communication devices 205-1, 205-2 are capable of multiple-input multiple-output (MIMO) communications, where a plurality of signals may be simultaneously transmitted and/or received between the communication devices 205-1, 205-2 using multipath propagation on a same wireless channel 260. In some embodiments, the signals are modulated using any suitable technique, such as orthogonal frequency-division multiplexing (OFDM), orthogonal frequency-division multiple access (OFDMA), binary phase shift keying (BPSK), quadrature phase shift keying (QPSK), quadrature amplitude modulation (QAM), and so forth. In some embodiments, the one or more antennae 255-1, 255-2 each comprise a respective plurality of antennae. In other embodiments, a first one of the antenna (e) 255-1, 255-2 comprises a plurality of antennae, and a second one of the antenna (e) 255-1, 255-2 comprises a single antenna.

The MIMO communications between the communication devices 205-1, 205-2 may be modeled as:

y=Hs+n (1)

where y∈ [symbol] ^{N}^{ₜ}, H∈ [symbol] ^{M⊗N}^{ₜ}, s∈ [symbol] ^{N}^{ₜ}, and n~ [symbol] [symbol] (0, N₀). M represents the number of transmit antenna (e) (in this example, the antenna (e) 255-1), N represents the number of receive antenna (e) (in this example, the antenna (e) 255-2), and No represents the noise variance. The symbol s belongs to a subspace [symbol] ^{N}^{ₜ} representing the signal constellation of the symbols. This subspace [symbol] ^{N}^{ₜ} may vary based on the number of transmit antenna(e) Nₜ and the selected modulation technique.

Thus, the communication device 205-2 receives a symbol vector y, and using the channel matrix H for the wireless channel 260, determines which symbol s was transmitted by the communication device 205-1. To determine the symbol s (sometimes referred to as soft MIMO detection), the communication device 205-2 determines how likely each bit of the symbol s has a zero value or a one value. The symbol s may be represented as a symbol vector (e.g., a bit string):

$$s = [ \begin{matrix}{s}_{1} \\ ⋮ \\ {s}_{{N}_{t}}\end{matrix} ] \qquad ( 2 )$$

The soft MIMO detection problem may be represented as an a posteriori Log-Likelihood ratio:

$$l ( {b}_{i} \vert y ) = log [ \frac{P ( {b}_{i} = 1 \vert y )}{P ( {b}_{i} = 0 \vert y )} ] \qquad ( 3 )$$

$$l ( {b}_{i} \vert y ) = log [ \frac{{\sum }_{{b}_{i} ( s ) = 1} {e}^{\frac{1}{N {-}_{0}} {‖ y - Hs ‖}^{2}}}{{\sum }_{{b}_{i} ( s ) = 0} {e}^{- \frac{1}{{N}_{0}} {‖ y - Hs ‖}^{2}}} ] \qquad ( 4 )$$

where Σ_{b}_{ᵢ₍ₛ₎₌₁} represents the sum over all possible vectors s in which the i^{th} bit is equal to 1, and Σ_{b}_{ᵢ₍ₛ₎₌₀} represents the sum over all possible vectors s in which the ith bit is equal to 0. The two subspaces bᵢ(s)=1 (referred to as [symbol] ₁) and bᵢ(s)=0 (referred to as [symbol] ₀) are disjoint subspaces of [symbol] ^{N}^{ₜ}

Using the max-log approximation, Equation (4) may be rewritten as:

$$l ( {b}_{i} \vert y ) \approx \frac{1}{{N}_{0}} [ {min}_{s ∈ {𝔹}_{0}} {‖ y - Hs ‖}^{2} - {min}_{s ∈ {𝔹}_{1}} {‖ y - Hs ‖}^{2} ] \qquad ( 5 )$$

which yields two optimization problems per bit. The two optimal symbol vectors are searched in the disjoint subspaces [symbol] ₁ and [symbol] ₀, and once found, the respective minimums ∥y−Hs∥² may be determined. The QUBO model for one of the optimization problems for the i^{th} bit of the symbol vector may be represented as:

$$Objective function : {min}_{s} {‖ y - Hs ‖}^{2} \qquad ( 6 )$$

$$Constraint : {b}_{i} ( s ) = 0 \qquad ( 7 )$$

Using QPSK modulation, each symbol entry sᵢ may be represented as a complex number.

$${s}_{i} = {s}_{i}^{I} + {js}_{i}^{Q} ,$$

and the possible states for the symbol entry sᵢ are {+1, +j}. In other words, the real part of the symbol entry sᵢ can have values

$${s}_{i}^{I} ∈ \{ - 1 , + 1 \}$$

and the complex part of the symbol entry sᵢ can have values

$${s}_{i}^{Q} ∈ \{ - 1 , + 1 \} .$$

The real part and the complex part are each represented using a respective binary decision variable qᵢ. Thus, the symbol entry sᵢ may be mapped using the following transformation:

Sí=>(2q2i−1−1)+j(2q2i−1) (8)

The quadratic form of the objection function of Equation (6) may be determined according to Equations (9)-(18):

$$Hs = y = [ \begin{matrix}{h}_{11} & ⋯ & {h}_{1 {N}_{t}} \\ ⋮ & ⋱ & ⋮ \\ {h}_{M 1} & ⋯ & {h}_{{MN}_{t}}\end{matrix} ] [ \begin{matrix}{s}_{1} \\ ⋮ \\ {s}_{{N}_{t}}\end{matrix} ] = [ \begin{matrix}{y}_{1} \\ ⋮ \\ {y}_{{N}_{t}}\end{matrix} ] \qquad ( 9 )$$

$$[ \begin{matrix}{h}_{11}^{R e} + {jh}_{11}^{Im} & ⋯ & {h}_{1 {N}_{t}}^{R e} + {jh}_{1 {N}_{t}}^{Im} \\ ⋮ & ⋱ & ⋮ \\ {h}_{M 1}^{R e} + {jh}_{M 1}^{Im} & ⋯ & {h}_{{MN}_{t}}^{R e} + {jh}_{{MN}_{t}}^{Im}\end{matrix} ] [ \text{} \begin{matrix}( 2 {q}_{1} - 1 ) + j ( 2 {q}_{2} - 1 ) \\ ⋮ \\ ( 2 {q}_{2 {N}_{t} - 1} - 1 ) + j ( 2 {q}_{2 {N}_{t}} - 1 )\end{matrix} ] = [ \text{} \begin{matrix}{y}_{1}^{R e} + {jy}_{1}^{Im} \\ ⋮ \\ {y}_{{N}_{t}}^{R e} + {jy}_{{N}_{t}}^{Im}\end{matrix} ] \qquad ( 10 )$$

$$[ \begin{matrix}{h}_{11}^{R e} & ⋯ & {h}_{1 {N}_{t}}^{R e} \\ ⋮ & ⋱ & ⋮ \\ {h}_{M 1}^{R e} & ⋯ & {h}_{{MN}_{t}}^{R e}\end{matrix} ] [ \text{} \begin{matrix}( 2 {q}_{1} - 1 ) \\ ⋮ \\ ( 2 {q}_{2 {N}_{t} - 1} - 1 )\end{matrix} ] + j [ \begin{matrix}{h}_{11}^{Im} & ⋯ & {h}_{1 {N}_{t}}^{Im} \\ ⋮ & ⋱ & ⋮ \\ {h}_{M 1}^{Im} & ⋯ & {h}_{{MN}_{t}}^{Im}\end{matrix} ] [ \text{} \begin{matrix}( 2 {q}_{2} - 1 ) \\ ⋮ \\ ( ( 2 {q}_{2 {N}_{t}} - 1 )\end{matrix} ] = [ \begin{matrix}{y}_{1}^{R e} \\ ⋮ \\ {y}_{{N}_{t}}^{R e}\end{matrix} ] + j [ \begin{matrix}{y}_{1}^{Im} \\ ⋮ \\ {y}_{{N}_{t}}^{Im}\end{matrix} ] \qquad ( 11 )$$

$$y - Hs = ( [ \begin{matrix}{y}_{1}^{R e} \\ ⋮ \\ {y}_{{N}_{t}}^{R e}\end{matrix} ] - [ \begin{matrix}{h}_{11}^{R e} & ⋯ & {h}_{1 {N}_{t}}^{R e} \\ ⋮ & ⋱ & ⋮ \\ {h}_{M 1}^{R e} & ⋯ & {h}_{{MN}_{t}}^{R e}\end{matrix} ] [ \text{} \begin{matrix}( 2 {q}_{1} - 1 ) \\ ⋮ \\ ( 2 {q}_{2 {N}_{t} - 1} - 1 )\end{matrix} ] ) + j ( [ \begin{matrix}{y}_{1}^{Im} \\ ⋮ \\ {y}_{{y}_{{N}_{t}}^{Im}}\end{matrix} ] - [ \begin{matrix}{h}_{11}^{Im} & ⋯ & {h}_{1 {N}_{t}}^{Im} \\ ⋮ & ⋱ & ⋮ \\ {h}_{M 1}^{Im} & ⋯ & {h}_{{MN}_{t}}^{Im}\end{matrix} ] [ \text{} \begin{matrix}( 2 {q}_{2} - 1 ) \\ ⋮ \\ ( ( 2 {q}_{2 {N}_{t}} - 1 )\end{matrix} ] ) \qquad ( 12 )$$

$${‖ y - Hs ‖}^{2} = {( \sqrt{{\sum }_{i = 1}^{M} {\vert {y}_{t} - {h}_{i} s \vert}^{2}} )}^{2} \qquad ( 13 )$$

where |·| represents the complex modulus.

$${‖ y - Hs ‖}^{2} = {\sum }_{i = 1}^{M} ( {( {y}_{i}^{R e} - {\sum }_{k = 1}^{{N}_{t}} {h}_{ik}^{R e} ( 2 {q}_{2 k - 1} - 1 ) )}^{2} + {( {y}_{i}^{Im} - {\sum }_{k = 1}^{{N}_{t}} {h}_{ik}^{Im} ( 2 {q}_{k} - 1 ) )}^{2} ) \qquad ( 14 )$$

$${‖ y - Hs ‖}^{2} = {\sum }_{i = 1}^{M} ( {y}_{i}^{R {e}^{2}} + {( {\sum }_{k = 1}^{{N}_{t}} {h}_{ik}^{R e} ( 2 {q}_{2 k - 1} - 1 ) )}^{2} - 2 {y}_{i}^{R e} {\sum }_{k = 1}^{{N}_{t}} {h}_{ik}^{R e} ( 2 {q}_{2 k - 1} - 1 ) + {y}_{i}^{{Im}^{2}} + {( {\sum }_{k = 1}^{{N}_{t}} {h}_{ik}^{Im} ( 2 {q}_{2 k} - 1 ) )}^{2} - 2 {y}_{i}^{Im} {\sum }_{k = 1}^{{N}_{t}} {h}_{ik}^{Im} ( 2 {q}_{2 k} - 1 ) ) \qquad ( 15 )$$

$${‖ y - Hs ‖}^{2} = {\sum }_{i = 1}^{M} ( {y}_{i}^{R {e}^{2}} + {y}_{i}^{{Im}^{2}} + {( {\sum }_{k = 1}^{{N}_{t}} {h}_{ik}^{R e} ( 2 {q}_{2 k - 1} - 1 ) )}^{2} + {( {\sum }_{k = 1}^{{N}_{t}} {h}_{ik}^{Im} ( 2 {q}_{2 k} - 1 ) )}^{2} - 4 {y}_{i}^{R e} {\sum }_{k = 1}^{{N}_{t}} {h}_{ik}^{R e} {q}_{2 k - 1} + {y}_{i}^{R e} {\sum }_{k = 1}^{{N}_{t}} {h}_{ik}^{R e} - 4 {y}_{i}^{Im} {\sum }_{k = 1}^{{N}_{t}} {h}_{ik}^{Im} {q}_{2 k} + 4 {y}_{i}^{Im} {\sum }_{k = 1}^{{N}_{t}} {h}_{ik}^{Im} ) \qquad ( 16 )$$

$${‖ y - Hs ‖}^{2} = {\sum }_{i = 1}^{M} ( {y}_{i}^{R {e}^{2}} + {y}_{i}^{{Im}^{2}} + {\sum }_{k = 1}^{{N}_{t}} {{h}_{ik}^{R {e}^{2}} ( 2 {q}_{2 k - 1} - 1 )}^{2} + {\sum }_{k = 1}^{{N}_{t} - 1} {\sum }_{l = k + 1}^{{N}_{t}} {h}_{ik}^{R e} ( 2 {q}_{2 k - 1} - 1 ) {h}_{il}^{R e} ( 2 {q}_{2 l - 1} - 1 ) + {\sum }_{k = 1}^{{N}_{t}} {{h}_{ik}^{{Im}^{2}} ( 2 {q}_{2 k} - 1 )}^{2} + 2 {\sum }_{k = 1}^{{N}_{t} - 1} {\sum }_{l = k + 1}^{{N}_{t}} {h}_{ik}^{Im} ( 2 {q}_{2 k} - 1 ) {h}_{il}^{Im} ( 2 {q}_{2 l} - 1 ) - 4 {y}_{i}^{R e} {\sum }_{k = 1}^{{N}_{t}} {h}_{ik}^{R e} {q}_{2 k - 1} + {y}_{i}^{R e} {\sum }_{k = 1}^{{N}_{t}} {h}_{ik}^{R e} - 4 {y}_{i}^{Im} {\sum }_{k = 1}^{{N}_{t}} {h}_{ik}^{Im} {q}_{2 k} + 4 {y}_{i}^{Im} {\sum }_{k = 1}^{{N}_{t}} {h}_{ik}^{Im} ) \qquad ( 17 )$$

$${‖ y - Hs ‖}^{2} = {\sum }_{i = 1}^{M} ( {y}_{i}^{R {e}^{2}} + {y}_{i}^{{Im}^{2}} + 4 {\sum }_{k = 1}^{{N}_{t}} {h}_{ik}^{R {e}^{2}} {q}_{2 k - 1}^{2} - 4 {\sum }_{k = 1}^{{N}_{t}} {h}_{ik}^{R {e}^{2}} {q}_{2 k - 1} + {\sum }_{k = 1}^{{N}_{t}} {h}_{ik}^{R {e}^{2}} + 8 {\sum }_{k = 1}^{{N}_{t} - 1} {\sum }_{l = k + 1}^{{N}_{t}} {h}_{ik}^{R e} {h}_{il}^{R e} {q}_{2 k - 1} {q}_{2 l - 1} - 4 {\sum }_{k = 1}^{{N}_{t} - 1} {\sum }_{l = k + 1}^{{N}_{t}} {h}_{ik}^{R e} {h}_{il}^{R e} {q}_{2 k - 1} - 4 {\sum }_{k = 1}^{{N}_{t} - 1} {\sum }_{l = k + 1}^{{N}_{t}} {h}_{ik}^{R e} {h}_{il}^{R e} {q}_{2 l - 1} + {\sum }_{k = 1}^{{N}_{t} - 1} {\sum }_{l = k + 1}^{{N}_{t}} {h}_{ik}^{R e} {h}_{il}^{R e} + 4 {\sum }_{k = 1}^{{N}_{t}} {h}_{ik}^{{Im}^{2}} {q}_{2 k}^{2} - 4 {\sum }_{k = 1}^{{N}_{t}} {h}_{ik}^{{Im}^{2}} {q}_{2 k} + {\sum }_{k = 1}^{{N}_{t}} {h}_{ik}^{{Im}^{2}} + 8 {\sum }_{k = 1}^{{N}_{t} - 1} {\sum }_{l = k + 1}^{{N}_{t}} {h}_{ik}^{Im} {h}_{il}^{Im} {q}_{2 k} {q}_{2 l} - 4 {\sum }_{k = 1}^{{N}_{t} - 1} {\sum }_{l = k + 1}^{{N}_{t}} {h}_{ik}^{Im} {h}_{il}^{Im} {q}_{2 k} - 4 {\sum }_{k = 1}^{{N}_{t} - 1} {\sum }_{l = k + 1}^{{N}_{t}} {h}_{ik}^{Im} {h}_{il}^{Im} {q}_{2 l} + {\sum }_{k = 1}^{{N}_{t} - 1} {\sum }_{l = k + 1}^{{N}_{t}} {h}_{ik}^{Im} {h}_{il}^{Im} - 4 {y}_{i}^{R e} {\sum }_{k = 1}^{{N}_{t}} {h}_{ik}^{R e} {q}_{2 k - 1} + {y}_{i}^{R e} {\sum }_{k = 1}^{{N}_{t}} {h}_{ik}^{R e} - 4 {y}_{i}^{Im} {\sum }_{k = 1}^{{N}_{t}} {h}_{ik}^{Im} {q}_{2 k} + 4 {y}_{i}^{Im} {\sum }_{k = 1}^{{N}_{t}} {h}_{ik}^{Im} ) \qquad ( 18 )$$

Assuming that the constant terms of

$${y}_{i}^{R {e}^{2}} , {y}_{i}^{{Im}^{2}} , {\sum }_{k = 1}^{{N}_{t}} {h}_{ik}^{R {e}^{2}} , {\sum }_{k = 1}^{{N}_{t} - 1} {\sum }_{l = k + 1}^{{N}_{t}} {h}_{ik}^{R e} {h}_{il}^{R e} , {\sum }_{k = 1}^{{N}_{t}} {h}_{ik}^{{Im}^{2}} , \\ {\sum }_{k = 1}^{{N}_{t} - 1} {\sum }_{l = k + 1}^{{N}_{t}} {h}_{ik}^{Im} {h}_{il}^{Im} , {y}_{i}^{R e} {\sum }_{k = 1}^{{N}_{t}} {h}_{ik}^{R e} , 4 {y}_{i}^{Im} {\sum }_{k = 1}^{{N}_{t}} {h}_{ik}^{Im} )$$

are considered negligible:

$${‖ y - Hs ‖}^{2} = {\sum }_{i = 1}^{M} ( 4 {\sum }_{k = 1}^{{N}_{t}} {h}_{ik}^{R {e}^{2}} {q}_{2 k - 1}^{2} - 4 {\sum }_{k = 1}^{{N}_{t}} {h}_{ik}^{R {e}^{2}} {q}_{2 k - 1} + 8 {\sum }_{k = 1}^{{N}_{t} - 1} {\sum }_{l = k + 1}^{{N}_{t}} {h}_{ik}^{R e} {h}_{il}^{R e} {q}_{2 k - 1} {q}_{2 l - 1} - 4 {\sum }_{k = 1}^{{N}_{t} - 1} {\sum }_{l = k + 1}^{{N}_{t}} {h}_{ik}^{R e} {h}_{il}^{R e} {q}_{2 k - 1} - 4 {\sum }_{k = 1}^{{N}_{t} - 1} {\sum }_{l = k + 1}^{{N}_{t}} {h}_{ik}^{R e} {h}_{il}^{R e} {q}_{2 l - 1} + 4 {\sum }_{k = 1}^{{N}_{t}} {h}_{ik}^{{Im}^{2}} {q}_{2 k}^{2} - 4 {\sum }_{k = 1}^{{N}_{t}} {h}_{ik}^{{Im}^{2}} {q}_{2 k} + 8 {\sum }_{k = 1}^{{N}_{t} - 1} {\sum }_{l = k + 1}^{{N}_{t}} {h}_{ik}^{Im} {h}_{il}^{Im} {q}_{2 k} {q}_{2 l} - 4 {\sum }_{k = 1}^{{N}_{t} - 1} {\sum }_{l = k + 1}^{{N}_{t}} {h}_{ik}^{Im} {h}_{il}^{Im} {q}_{2 k} - 4 {\sum }_{k = 1}^{{N}_{t} - 1} {\sum }_{l = k + 1}^{{N}_{t}} {h}_{ik}^{Im} {h}_{il}^{Im} {q}_{2 l} - 4 {y}_{i}^{R e} {\sum }_{k = 1}^{{N}_{t}} {h}_{ik}^{R e} {q}_{2 k - 1} - 4 {y}_{i}^{Im} {\sum }_{k = 1}^{{N}_{t}} {h}_{ik}^{Im} {q}_{2 k} ) \qquad ( 19 )$$

For an example case of 2×2 MIMO communications (that is, M=Nₜ=2):

$${‖ y - Hs ‖}^{2} = {\sum }_{i = 1}^{2} ( 4 {\sum }_{k = 1}^{2} {h}_{ik}^{R {e}^{2}} {q}_{2 k - 1}^{2} - 4 {\sum }_{k = 1}^{2} {h}_{ik}^{R {e}^{2}} {q}_{2 k - 1} + 8 {\sum }_{k = 1}^{1} {\sum }_{l = k + 1}^{2} {h}_{ik}^{R e} {h}_{il}^{R e} {q}_{2 k - 1} {q}_{2 l - 1} - 4 {\sum }_{k = 1}^{1} {\sum }_{l = k + 1}^{2} {h}_{ik}^{R e} {h}_{il}^{R e} {q}_{2 k - 1} - 4 {\sum }_{k = 1}^{1} {\sum }_{l = k + 1}^{2} {h}_{ik}^{R e} {h}_{il}^{R e} {q}_{2 l - 1} + 4 {\sum }_{k = 1}^{2} {h}_{ik}^{{Im}^{2}} {q}_{2 k}^{2} - 4 {\sum }_{k = 1}^{2} {h}_{ik}^{{Im}^{2}} {q}_{2 k} + 8 {\sum }_{k = 1}^{1} {\sum }_{l = k + 1}^{2} {h}_{ik}^{Im} {h}_{il}^{Im} {q}_{2 k} {q}_{2 l} - 4 {\sum }_{k = 1}^{1} {\sum }_{l = k + 1}^{2} {h}_{ik}^{Im} {h}_{il}^{Im} {q}_{2 k} - 4 {\sum }_{k = 1}^{1} {\sum }_{l = k + 1}^{2} {h}_{ik}^{Im} {h}_{il}^{Im} {q}_{2 l} - 4 {y}_{i}^{R e} {\sum }_{k = 1}^{2} {h}_{ik}^{R e} {q}_{2 k - 1} - 4 {y}_{i}^{Im} {\sum }_{k = 1}^{2} {h}_{ik}^{Im} {q}_{2 k} ) \qquad ( 20 )$$

$${‖ y - Hs ‖}^{2} = {\sum }_{i = 1}^{2} ( 4 {h}_{i 1}^{R {e}^{2}} {q}_{1}^{2} + 4 {h}_{i 2}^{R {e}^{2}} {q}_{3}^{2} - 4 {h}_{i 1}^{R {e}^{2}} {q}_{1} - 4 {h}_{i 2}^{R {e}^{2}} {q}_{3} + 8 {h}_{i 1}^{R e} {h}_{i 2}^{R e} {q}_{1} {q}_{3} - 4 {h}_{i 1}^{R e} {h}_{i 2}^{R e} {q}_{1} - 4 {h}_{i 1}^{R e} {h}_{i 2}^{R e} {q}_{3} + 4 {h}_{i 1}^{{Im}^{2}} {q}_{2}^{2} + 4 {h}_{i 2}^{{Im}^{2}} {q}_{4}^{2} - 4 {h}_{i 1}^{{Im}^{2}} {q}_{2} - 4 {h}_{i 2}^{{Im}^{2}} {q}_{4} + 8 {h}_{i 1}^{Im} {h}_{i 2}^{Im} {q}_{2} {q}_{4} - 4 {h}_{i 1}^{Im} {h}_{i 2}^{Im} {q}_{2} - 4 {h}_{i 1}^{Im} {h}_{i 2}^{Im} {q}_{4} - 4 {y}_{i}^{R e} {h}_{i 1}^{R e} {q}_{1} - 4 {y}_{i}^{R e} {h}_{i 2}^{R e} {q}_{3} - 4 {y}_{i}^{Im} {h}_{i 1}^{Im} {q}_{2} - 4 {y}_{i}^{Im} {h}_{i 2}^{Im} {q}_{4} ) \qquad ( 21 )$$

$${‖ y - Hs ‖}^{2} = 4 ( {h}_{11}^{R {e}^{2}} + {h}_{21}^{R {e}^{2}} ) {q}_{1}^{2} + 4 ( {h}_{11}^{{Im}^{2}} + {h}_{21}^{{Im}^{2}} ) {q}_{2}^{2} + 4 ( {h}_{12}^{R {e}^{2}} + {h}_{22}^{R {e}^{2}} ) {q}_{3}^{2} + 4 ( {h}_{12}^{{Im}^{2}} + {h}_{22}^{{Im}^{2}} ) {q}_{4}^{2} - 4 ( {h}_{11}^{R {e}^{2}} + {h}_{21}^{R {e}^{2}} + {h}_{11}^{R e} {h}_{12}^{R e} + {h}_{21}^{R e} {h}_{22}^{R e} + {y}_{1}^{R e} {h}_{11}^{R e} + {y}_{2}^{R e} {h}_{21}^{R e} ) {q}_{1} - 4 ( {h}_{11}^{{Im}^{2}} + {h}_{21}^{{Im}^{2}} + {h}_{11}^{Im} {h}_{12}^{Im} + {h}_{21}^{Im} {h}_{22}^{Im} + {y}_{1}^{Im} {h}_{11}^{Im} + {y}_{2}^{Im} {h}_{21}^{Im} ) {q}_{2} - 4 ( {h}_{11}^{R e} {h}_{12}^{R e} + {h}_{21}^{R e} {h}_{22}^{R e} + {y}_{1}^{R e} {h}_{12}^{R e} + {y}_{2}^{R e} {h}_{22}^{R e} ) {q}_{3} - 4 ( {h}_{12}^{{Im}^{2}} + {h}_{22}^{{Im}^{2}} + {h}_{11}^{Im} {h}_{12}^{Im} + {h}_{21}^{Im} {h}_{22}^{Im} + {y}_{1}^{Im} {h}_{12}^{Im} + {y}_{2}^{Im} {h}_{22}^{Im} ) {q}_{4} + 8 ( {h}_{11}^{R e} {h}_{12}^{R e} + {h}_{21}^{R e} {h}_{22}^{R e} ) {q}_{1} {q}_{3} + 8 ( {h}_{11}^{Im} {h}_{12}^{Im} + {h}_{21}^{Im} {h}_{22}^{Im} ) {q}_{2} {q}_{4} \qquad ( 22 )$$

As each binary decision variable qᵢ∈{0,1}, qᵢ=qᵢ² and Equation (22) can be simplified as:

$${‖ y - Hs ‖}^{2} = 4 ( {h}_{11}^{R {e}^{2}} + {h}_{21}^{R {e}^{2}} - {h}_{11}^{R {e}^{2}} - {h}_{21}^{R {e}^{2}} - {h}_{11}^{R e} {h}_{12}^{R e} - {h}_{21}^{R e} {h}_{22}^{R e} - {y}_{1}^{R e} {h}_{11}^{R e} - {y}_{2}^{R e} {h}_{21}^{R e} ) {q}_{1}^{2} + 4 ( {h}_{11}^{{Im}^{2}} + {h}_{21}^{{Im}^{2}} - {h}_{11}^{{Im}^{2}} - {h}_{21}^{{Im}^{2}} - {h}_{11}^{Im} {h}_{12}^{Im} - {h}_{21}^{Im} {h}_{22}^{Im} - {y}_{1}^{Im} {h}_{11}^{Im} - {y}_{2}^{Im} {h}_{21}^{Im} ) {q}_{2}^{2} + 4 ( {h}_{12}^{R {e}^{2}} + {h}_{22}^{R {e}^{2}} - {h}_{11}^{R e} {h}_{12}^{R e} - {h}_{21}^{R e} {h}_{22}^{R e} - {y}_{1}^{R e} {h}_{12}^{R e} - {y}_{2}^{R e} {h}_{22}^{R e} ) {q}_{3}^{2} + 4 ( {h}_{12}^{{Im}^{2}} + {h}_{22}^{{Im}^{2}} - {h}_{12}^{{Im}^{2}} - {h}_{22}^{{Im}^{2}} - {h}_{11}^{Im} {h}_{12}^{Im} - {h}_{21}^{Im} {h}_{22}^{Im} - {y}_{1}^{Im} {h}_{12}^{Im} - {y}_{2}^{Im} {h}_{22}^{Im} ) {q}_{4}^{2} + 8 ( {h}_{11}^{R e} {h}_{12}^{R e} + {h}_{21}^{R e} {h}_{22}^{R e} ) {q}_{1} {q}_{3} + 8 ( {h}_{11}^{Im} {h}_{12}^{Im} + {h}_{21}^{Im} {h}_{22}^{Im} ) {q}_{2} {q}_{4} \qquad ( 23 )$$

$${‖ y - Hs ‖}^{2} = - 4 ( {h}_{11}^{R e} {h}_{12}^{R e} + {h}_{21}^{R e} {h}_{22}^{R e} + {y}_{1}^{R e} {h}_{11}^{R e} + {y}_{2}^{R e} {h}_{21}^{R e} ) {q}_{1}^{2} - 4 ( {h}_{11}^{Im} {h}_{12}^{Im} + {h}_{21}^{Im} {h}_{22}^{Im} + {y}_{1}^{Im} {h}_{11}^{Im} + {y}_{2}^{Im} {h}_{21}^{Im} ) {q}_{2}^{2} + 4 ( {h}_{12}^{R {e}^{2}} + {h}_{22}^{R {e}^{2}} - {h}_{11}^{R e} {h}_{12}^{R e} - {h}_{21}^{R e} {h}_{22}^{R e} - {y}_{1}^{R e} {h}_{12}^{R e} - {y}_{2}^{R e} {h}_{22}^{R e} ) {q}_{3}^{2} - 4 ( {h}_{11}^{Im} {h}_{12}^{Im} + {h}_{21}^{Im} {h}_{22}^{Im} + {y}_{1}^{Im} {h}_{12}^{Im} + {y}_{2}^{Im} {h}_{22}^{Im} ) {q}_{4}^{2} + 8 ( {h}_{11}^{R e} {h}_{12}^{R e} + {h}_{21}^{R e} {h}_{22}^{R e} ) {q}_{1} {q}_{3} + 8 ( {h}_{11}^{Im} {h}_{12}^{Im} + {h}_{21}^{Im} {h}_{22}^{Im} ) {q}_{2} {q}_{4} \qquad ( 24 )$$

Adding a penalty term for the constraint of Equation (7), the Log-Likelihood ratio of the ith bit being equal to one or zero given the symbol vector y is expressed as:

$$l ( {q}_{i} \vert y ) \approx \frac{1}{{N}_{0}} [ ( {min}_{s} {‖ y - Hs ‖}^{2} + {λ}_{i} {q}_{i}^{2} ) - ( {min}_{s} {‖ y - Hs ‖}^{2} + {{λ}_{i} ( {q}_{i} - 1 )}^{2} ) ] \qquad ( 25 )$$

The QUBO model for optimizing the first term of Equation (25) for the binary decision variable q₁, for the 2×2 MIMO and QPSK example:

$${min}_{s} {‖ y - Hs ‖}^{2} + {λ}_{i} {q}_{i}^{2} = - 4 ( {h}_{11}^{R e} {h}_{12}^{R e} + {h}_{21}^{R e} {h}_{22}^{R e} + {y}_{1}^{R e} {h}_{11}^{R e} + {y}_{2}^{R e} {h}_{21}^{R e} + \frac{{λ}_{1}}{4} ) {q}_{1}^{2} - 4 ( {h}_{11}^{Im} {h}_{12}^{Im} + {h}_{21}^{Im} {h}_{22}^{Im} + {y}_{1}^{Im} {h}_{11}^{Im} + {y}_{2}^{Im} {h}_{21}^{Im} ) {q}_{2}^{2} + 4 ( {h}_{12}^{R {e}^{2}} + {h}_{22}^{R {e}^{2}} - {h}_{11}^{R e} {h}_{12}^{R e} - {h}_{21}^{R e} {h}_{22}^{R e} - {y}_{1}^{R e} {h}_{12}^{R e} - {y}_{2}^{R e} {h}_{22}^{R e} ) {q}_{3}^{2} - 4 ( {h}_{11}^{Im} {h}_{12}^{Im} + {h}_{21}^{Im} {h}_{22}^{Im} + {y}_{1}^{Im} {h}_{12}^{Im} + {y}_{2}^{Im} {h}_{22}^{Im} ) {q}_{4}^{2} + 8 ( {h}_{11}^{R e} {h}_{12}^{R e} + {h}_{21}^{R e} {h}_{22}^{R e} ) {q}_{1} {q}_{3} + 8 ( {h}_{11}^{Im} {h}_{12}^{Im} + {h}_{21}^{Im} {h}_{22}^{Im} ) {q}_{2} {q}_{4} \qquad ( 26 )$$

Thus, the QUBO matrix for

$${min}_{s} {‖ y - Hs ‖}^{2} - {λ}_{1} {q}_{1}$$

in 2×2 MIMO and QPSK example case may be calculated as:

$$Q = [ \begin{matrix}{Q}_{11} & 0 & {Q}_{13} & 0 \\ 0 & {Q}_{22} & 0 & {Q}_{24} \\ {Q}_{13} & 0 & {Q}_{33} & 0 \\ 0 & {Q}_{24} & 0 & {Q}_{44}\end{matrix} ] \qquad ( 27 )$$

$${Q}_{11} = - 4 ( {h}_{11}^{R e} {h}_{12}^{R e} + {h}_{21}^{R e} {h}_{22}^{R e} + {y}_{1}^{R e} {h}_{11}^{R e} + {y}_{2}^{R e} {h}_{21}^{R e} ) + {λ}_{1} \qquad ( 28 )$$

$${Q}_{22} = - 4 ( {h}_{11}^{I m} {h}_{12}^{I m} + {h}_{21}^{I m} {h}_{22}^{I m} + {y}_{1}^{I m} {h}_{11}^{I m} + {y}_{2}^{I m} {h}_{21}^{I m} ) \qquad ( 29 )$$

$${Q}_{33} = 4 ( {h}_{12}^{R {e}^{2}} + {h}_{22}^{R {e}^{2}} - {h}_{11}^{R e} {h}_{12}^{R e} - {h}_{21}^{R e} {h}_{22}^{R e} - {y}_{1}^{R e} {h}_{12}^{R e} - {y}_{2}^{R e} {h}_{22}^{R e} ) \qquad ( 30 )$$

$${Q}_{44} = - 4 ( {h}_{11}^{I m} {h}_{12}^{I m} + {h}_{21}^{I m} {h}_{22}^{I m} + {y}_{1}^{I m} {h}_{12}^{I m} + {y}_{2}^{I m} {h}_{22}^{I m} ) \qquad ( 31 )$$

$${Q}_{13} = 8 ( {h}_{11}^{R e} {h}_{12}^{R e} + {h}_{21}^{R e} {h}_{22}^{R e} ) \qquad ( 32 )$$

$${Q}_{24} = 8 ( {h}_{11}^{I m} {h}_{12}^{I m} + {h}_{21}^{I m} {h}_{22}^{I m} ) \qquad ( 33 )$$

According to various embodiments discussed herein, one or both of the communication devices 205-1, 205-2 comprise a QUBO problem solver service 230-1, 230-2 that configures and/or operates a neural network 235-1, 235-2 of the respective communication device 205-1, 205-2 to solve a QUBO problem. In some embodiments, the QUBO problem solver service 230-1, 230-2 represents code that is executed by the one or more processors 210-1, 210-2 and that operates to simulate the various neurons and synapses of the neural network 235-1, 235-2. In other embodiments, the one or more processors 210-1, 210-2 comprises the neuromorphic hardware 220-1, 220-2 that is connected with a host CPU 235-1, 235-2. In this case, the QUBO problem solver service 230-1, 230-2 represents code that is executed by the host CPU 235-1, 235-2 (or other logic included in the processors 210-1, 210-2) to configure the neural network 235-1, 235-2 implemented using the neuromorphic hardware 220-1, 220-2. The neuromorphic hardware 220-1, 220-2 includes circuitry that mimics neuro-biological architectures of a nervous system, e.g., arranged as neurons and synapses. Some non-limiting examples of the neuromorphic hardware 220-1, 220-2 include the TrueNorth integrated circuit (produced by IBM), the Loihi integrated circuit (produced by Intel), the SpiNNaker supercomputer architecture (developed by the University of Manchester), as well as other standardized or proprietary neuromorphic designs. In this case, the QUBO problem solver service 230-1, 230-2 may be executed by the host CPU 215-1, 215-2 to configure and/or operate the neuromorphic hardware 220-1, 220-2 to implement the various neurons and synapses of the neural network 235-1, 235-2.

The use of the neural network 235-1, 235-2 to solve the objective function of the QUBO problem can provide a number of benefits. For example, the neural network 235-1, 235-2 provides a more energy efficient approach when compared to conventional computational techniques (e.g., applying heuristics) for solving the QUBO problem. Such energy savings are even more pronounced for those implementations of the electronic device 202-1, 202-2 using the neuromorphic hardware 220-1, 220-2 to implement the neural network 235-1, 235-2.

Further, the electronic device 202-1, 202-2 may be capable of operating numerous neurons in parallel with each other (e.g., thousands or millions of neurons, or more), which allows the neural network 235-1, 235-2 to be scaled with increases in the problem size (e.g., for larger MIMO schemes such as 3×3, 4×4, 6×6, 8×8, and so forth, as well as for different modulation schemes). Still further, the neural network 235-1, 235-2 approximates a solution to the optimization problem and its constraints through the potentiation and inhibition of neurons, instead of through a direct calculation of the solution. Thus, the neural network 235-1, 235-2 is capable of providing an approximated solution within a suitable amount of time, which allows the neural network 235-1, 235-2 to be suitably responsive to be applied in the dynamic setting (e.g., employed by the electronic devices 202-1, 202-2 for MIMO communications within a mobile network).

In some embodiments, one or both of the communication devices 205-1, 205-2 further comprise a MIMO detector service 232-1, 232-2 that uses the solution generated by the QUBO problem solver service 230-1, 230-2 to detect symbol values in MIMO communications. The MIMO detector service 232-1, 232-2 represents code that is executed by the one or more processors 210-1, 210-2 to implement the functionality described herein for MIMO detection. In other embodiments, the functionality represented by the MIMO detector service 232-1, 232-2 in FIG. 2 may be integrated into the QUBO problem solver service 230-1, 230-2.

Returning to FIG. 1, the method 100 begins at optional block 105, where the communication device 205-2 receives a first symbol vector. In some embodiments, the communication device 205-2 receives the first symbol vector using a plurality of antennae. Notably, while the method 100 is described with reference to operation of the communication device 205-2, the person of ordinary skill will understand that the other communication devices 205-1 and/or other implementations of electronic devices may have similar operation, which in some cases may be performed contemporaneously with the operation of the communication device 205-2.

At optional block 110, the QUBO problem solver service 230-2 computes a QUBO matrix using the first symbol vector and a channel matrix. In some embodiments, the channel matrix is accessed as Channel State Information for the communication device 205-2. The QUBO problem solver service 230-2 may generally compute the QUBO matrix using the techniques discussed above with respect to Equations (1)-(33).

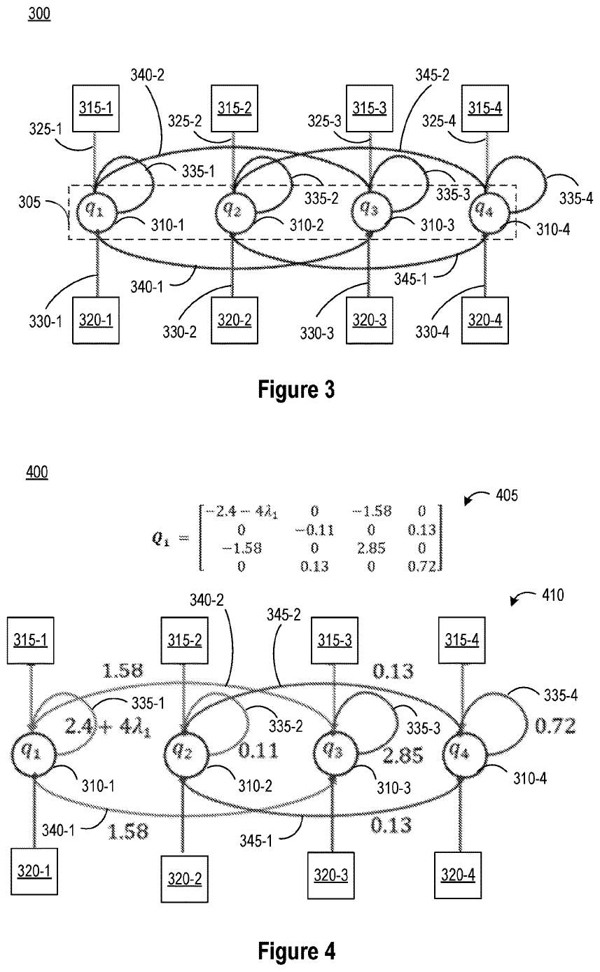

At block 115, the QUBO problem solver service 230-2 implements a plurality of neurons, where each neuron represents a respective binary decision variable of the QUBO problem (e.g., as represented in the QUBO matrix). Referring also to the neural network 300 illustrated in FIG. 3, the QUBO problem solver service 230-2 implements a plurality of neurons 305, where each neuron 310-1, 310-2, 310-3, 310-4 represents a respective binary decision variable q₁, q₂, q₃, q₄ of the QUBO problem. In some embodiments, each neuron 310-1, 310-2, 310-3, 310-4 is implemented as a spiking neuron (e.g., according to a leaky integrate and—fire neuron model). In some embodiments, the neural network 300 may be tuned by setting one or more parameters of the neurons 310-1, 310-2, 310-3, 310-4 (such as a bias value, a firing threshold value, time constants describing current leakage and/or voltage leakage, a refractory period, and so forth).

At optional block 120, the QUBO problem solver service 230-2 implements a plurality of excitatory noise sources 315-1, 315-2, 315-3, 315-4 and a plurality of inhibitory noise sources 320-1, 320-2, 320-3, 320-4, where each neuron 310-1, 310-2, 310-3, 310-4 is connected to a respective excitatory noise source 315-1, 315-2, 315-3, 315-4 and to a respective inhibitory noise source 320-1, 320-2, 320-3, 320-4. As shown in the neural network 300, the excitatory noise sources 315-1, 315-2, 315-3, 315-4 are connected to the respective neurons 310-1, 310-2, 310-3, 310-4 using a plurality of excitatory synapses 325-1, 325-2, 325-3, 325-4, and the inhibitory noise sources 320-1, 320-2, 320-3, 320-4 are connected to the respective neurons 310-1, 310-2, 310-3, 310-4 using a plurality of inhibitory synapses 330-1, 330-2, 330-3, 330-4.

In some embodiments, each excitatory noise source 315-1, 315-2, 315-3, 315-4 and each inhibitory noise source 320-1, 320-2, 320-3, 320-4 is implemented as a spiking neuron. In some embodiments, the spiking neurons of the excitatory noise sources 315-1, 315-2, 315-3, 315-4 and of the inhibitory noise sources 320-1, 320-2, 320-3, 320-4 executes the Poisson model for spike generation. In some embodiments, the neural network 300 may be tuned by setting one or more parameters of the excitatory noise sources 315-1, 315-2, 315-3, 315-4 and/or the inhibitory noise sources 320-1, 320-2, 320-3, 320-4 (such as a firing rate).

At block 125, the QUBO problem solver service 230-2 implements a first plurality of synapses 335-1, 335-2, 335-3, 335-4 as a plurality of recurrent synapses, where each recurrent synapse is connected to a respective neuron 310-1, 310-2, 310-3, 310-4 of the plurality of neurons. Each recurrent synapse has a respective weight corresponding to a diagonal coefficient of the QUBO matrix.

At block 130, the QUBO problem solver service 230-2 implements a second plurality of synapses 340-1, 340-2, 345-1, 345-2 as a plurality of lateral synapses extending between pairs of neurons of the plurality of neurons. Each lateral synapse has a respective weight corresponding to an off-diagonal coefficient of the QUBO matrix. As shown, the synapses 340-1, 340-2 connect the neurons 310-1, 310-3, and the synapses 345-1, 345-2 connect the neurons 310-2, 310-4. The synapse 340-1 connects an output of the neuron 310-1 to an input of the neuron 310-3, and the synapse 340-2 connects an output of the neuron 310-3 to an input of the neuron 310-1. The synapse 345-1 connects an output of the neuron 310-2 to an input of the neuron 310-4, and the synapse 345-2 connects an output of the neuron 310-4 to an input of the neuron 310-2.

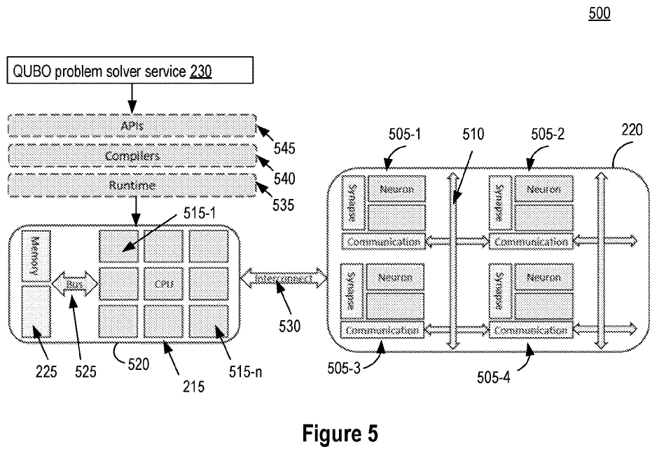

In some embodiments, for each synapse of the first plurality of synapses 335-1, 335-2, 335-3, 335-4 and of the second plurality of synapses 340-1, 340-2, 345-1, 345-2, the synapse is implemented as an excitatory synapse when the corresponding coefficient of the QUBO matrix has a negative sign, and the synapse is implemented as an inhibitory synapse when the corresponding coefficient of the QUBO matrix has a positive sign, e.g., as illustrated in FIG. 4 and discussed below.

Since the QUBO problem is framed as a minimization problem, the magnitude of the synaptic weights of the recurrent synapses (that is, the first plurality of synapses 335-1, 335-2, 335-3, 335-4) equals the diagonal coefficients of the QUBO matrix, but the recurrent synapses are excitatory if the synaptic weight is negative and inhibitory if the synaptic weight is positive.

For the diagonal coefficients of the QUBO matrix having a negative value (Qᵢᵢ<0), the excitatory recurrent synapses reinforce the spikes of the neurons that would correspond to decreases in the energy. Similarly, for the diagonal coefficients of the QUBO matrix having a positive value (Qᵢᵢ>0), the inhibitory recurrent synapses suppress the spikes of the neurons that would correspond to increases in the energy.

For the non-diagonal coefficients of the QUBO matrix Qᵢⱼ (where i>j) having a positive value, satisfying the constraint on the decision variables qᵢ and qⱼ corresponds to an undesired increase in the energy, and therefore inhibitory lateral synapses are created between the neurons nᵢ and nⱼ. For the non-diagonal coefficients of the QUBO matrix Qᵢⱼ (where i>j) having a negative value, satisfying the constraint on the decision variables qᵢ and qⱼ corresponds to a desired decrease in the energy, and therefore excitatory lateral synapses are created between the neurons nᵢ and nⱼ. The synapse is implemented as an inhibitory synapse when the corresponding coefficient of the QUBO matrix has a positive sign, e.g., as illustrated in FIG. 4 and discussed below.

At optional block 135, the communication device 205-2 receives a second symbol vector (e.g., using the plurality of antennae). At optional block 140, the communication device 205-2 decodes, using the plurality of neurons, the second symbol vector into a plurality of signals. The method 100 ends following completion of the optional block 140.

In some embodiments, one or more of the blocks 115-140 of the method 100 may be implemented using the pseudocode provided in Table 1.

TABLE 1
Pseudocode for implementing and operating neural network for QUBO problem.

```
#Define the problem QUBO = <Q, b>
Q = Symmetric Matrix (Coefficients)
B = List (Binary Decision Variables)
# Create one Neuron per decision variable and configure using state variables to record the spike
pattern
for variable i in B:
  neurons[i] = Create_Spiking_Neuron (parameters)
#Create excitatory noise input
for variable i in B:
  excitatory_noise_neuron[i] = Create_Poisson_Neuron ([positive] spike rate)
#Create inhibitory noise input
for variable i in B:
  inhibitory_noise_neuron[i] = Create_Poisson_Neuron ([negative] spike rate)
#Connect each neuron for the QUBO with excitatory noise input and/or inhibitory noise
for variable i in B:
  excitatory_noise_neuron[i].output.Connect (neurons[i].input)
  inhibitory_noise_noise_neuron[i].output.Connect (neurons[i].input)
#Create synapses with weights corresponding to the QUBO matrix entries
for variable i in B:
  for variable j in B:
    if Q [i, j] < 0:
      synapses [i, j] = Create_Excitatory_Synapse (weight=absolute (Q [i, j]))
    else if Q [i, j] > 0:
      synapses [i, j] = Create_Inhibitory_Synapse (weight=Q [i, j])
```

The blocks 110-130 of the method 100 will be further discussed with respect to diagram 400 of FIG. 4, which illustrates an exemplary implementation of a neural network 410 with recurrent synapses and lateral synapses having weights corresponding to values of a QUBO matrix 405, according to one or more embodiments. In the exemplary implementation, it will be assumed that the wireless channel 260 between the communication devices 205-1, 205-2 has a channel matrix H:

$$H = [ \begin{matrix}0.59 - 0.03 j & - 0 \text{.31} + 0.13 j \\ 0.3 + 0.05 j & - 0 \text{.05} + 0.46 j\end{matrix} ] \qquad ( 34 )$$

Thus, from the following symbol vector s transmitted by the communication device 205-1, and assuming a noise variance (N₀) of 0.2, the communication device 205-2 may receive the symbol vector y:

$$s = [ \begin{matrix}1 + j \\ - 1 + j\end{matrix} ] \qquad ( 35 )$$

$$y = [ \begin{matrix}1.36 + 0.43 j \\ - 0.03 + 0.55 j\end{matrix} ] \qquad ( 36 )$$

Using the techniques described above with respect to Equations (1)-(33), the QUBO problem solver service 230-2 may compute a QUBO matrix 405, which also represented as Equation (37):

$${Q}_{1} = [ \begin{matrix}- 2.4 - {λ}_{1} & 0 & - 1.58 & 0 \\ 0 & - 0.11 & 0 & 0.13 \\ - 1.58 & 0 & 2.85 & 0 \\ 0 & 0.13 & 0 & 0.72\end{matrix} ] \qquad ( 37 )$$

The QUBO problem solver service 230-2 implements the first plurality of (recurrent) synapses 335-1, 335-2, 335-3, 335-4 (block 125) and the second plurality of (lateral) synapses 340-1, 340-2, 345-1, 345-2 (block 130) using the QUBO matrix 405. In some embodiments, for each synapse of the first plurality of synapses 335-1, 335-2, 335-3, 335-4 and of the second plurality of synapses 340-1, 340-2, 345-1, 345-2, the synapse is implemented as an excitatory synapse when the corresponding coefficient of the QUBO matrix 405 has a negative sign, and the synapse is implemented as an inhibitory synapse when the corresponding coefficient of the QUBO matrix 405 has a positive sign.

Thus, using the QUBO matrix 405, the synapse 335-1 is an excitatory synapse with the value (2.4+λ₁), the synapse 335-2 is an excitatory synapse with the value 0.11, the synapse 335-3 is an inhibitory synapse with the value 2.85, and the synapse 335-4 is an inhibitory synapse with the value 0.72. The synapses 340-1, 340-2 are implemented as excitatory synapses with the value 1.58, and the synapses 345-1, 345-2 are implemented as inhibitory synapses with the value 0.13.

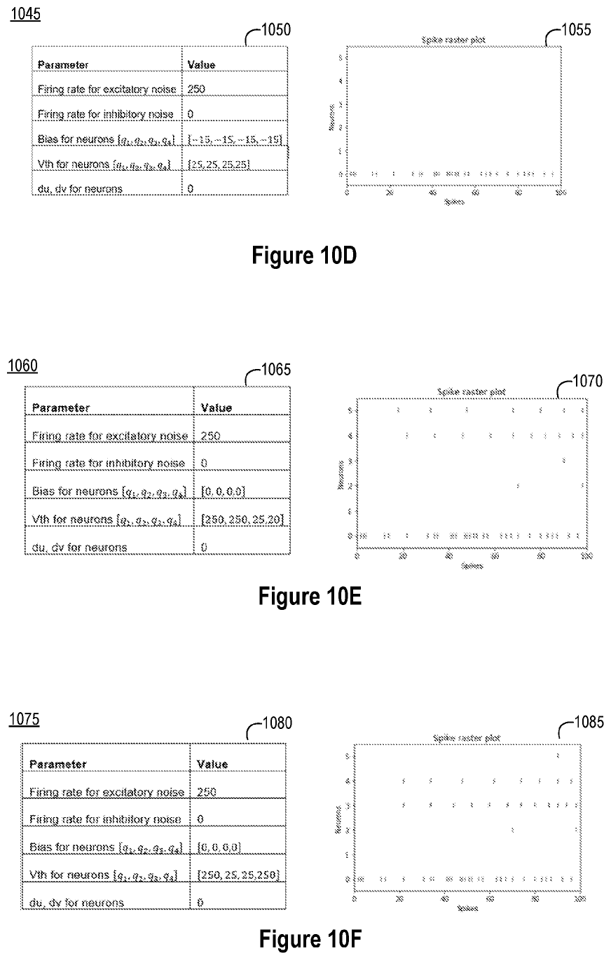

Diagram 1000 of FIG. 10A illustrates operation of the neural network 410 using a first set of tuning parameters that are shown in chart 1005. Assuming also that/1=0, plot 1010 illustrates the spiking of various neurons of the neural network 410. Specifically, index 0 represents an excitatory noise source 315, index 1 represents an inhibitory noise source 320, index 2 represents the neuron 310-1, index 3 represents the neuron 310-2, index 4 represents the neuron 310-3, and index 5 represents the neuron 310-4. The excitatory noise source 315 fires according to the firing rate specified in the chart 1005 (that is, 250), while the inhibitory noise source 320 does not fire as its firing rate is zero. The neurons 310-1, 310-2, and 310-4 spike at a rate greater than a threshold value, while the neuron 310-3 does not spike at such a rate.

Diagram 1015 of FIG. 10B illustrates operation of the neural network 410 using a second set of tuning parameters that are shown in chart 1020. Plot 1025 again illustrates that the neurons 310-1, 310-2, and 310-4 spike at a rate greater than a threshold value, while the neuron 310-3 does not spike at such a rate. Based on these results, the QUBO problem solver service 230-2 determines the values of the binary decision variables: [q₁, q₂, q₃, q₄]=[1, 1, 0,1].

In some embodiments, the QUBO problem solver service 230-2 provides these values to a MIMO detector service 232-2 performed by the processor(s) 210-2 of the communication device 205-2 to determine the symbol vector that was transmitted by the communication device 205-1. In other embodiments, the QUBO problem solver service 230-2 itself determines the symbol vector. Using the determined values of the binary decision variables, the symbol vector detected is:

$$s = [ \begin{matrix}( 2 {q}_{1} - 1 ) + j ( 2 {q}_{2} - 1 ) \\ ( 2 {q}_{1} - 1 ) + j ( 2 {q}_{2} - 1 )\end{matrix} ] = [ \begin{matrix}( 2 - 1 ) + j ( 2 - 1 ) \\ ( 0 - 1 ) + j ( 2 - 1 )\end{matrix} ] = [ \begin{matrix}1 + j \\ - 1 + j\end{matrix} ] \qquad ( 38 )$$

A comparable process is performed for the other possible states of the symbol vector s transmitted by the communication device 205-1. For the following value of the symbol vector s and assuming that 2₁=0:

$$s = [ \begin{matrix}- 1 - j \\ - 1 - j\end{matrix} ] \qquad ( 39 )$$

the QUBO problem solver service 230-2 computes the following QUBO matrix:

$${Q}_{2} = [ \begin{matrix}- 0.55 & 0 & - 1.58 & 0 \\ 0 & - 0.07 & 0 & 0.13 \\ - 1.58 & 0 & 1.713 & 0 \\ 0 & 0.13 & 0 & - 0.12\end{matrix} ] \qquad ( 40 )$$

The values of the QUBO matrix are mapped onto the first plurality of synapses 335-1, 335-2, 335-3, 335-4 and of the second plurality of synapses 340-1, 340-2, 345-1, 345-2 as discussed above. Diagram 1030 of FIG. 10C illustrates operation of the neural network 300 using a first set of tuning parameters that are shown in chart 1035. Plot 1040 illustrates the spiking of various neurons of the neural network 300. Here, none of the neurons 310-1, 310-2, 310-3, 310-4 spike at a rate greater than the threshold value. The same result is shown in plot 1055 (chart 1045 of FIG. 10D) corresponding to a second set of tuning parameters (chart 1045). The QUBO problem solver service 230-2 determines the values of the binary decision variables: [q₁, q₂, q₃, q₄]=[0, 0, 0, 0]. Using the determined values of the binary decision variables, the symbol vector detected is:

$$s = [ \begin{matrix}( 0 - 1 ) + j ( 0 - 1 ) \\ ( 0 - 1 ) + j ( 0 - 1 )\end{matrix} ] = [ \begin{matrix}- 1 - j \\ - 1 - j\end{matrix} ] \qquad ( 41 )$$

For the following value of the symbol vector s and assuming that/1=0:

$$s = [ \begin{matrix}- 1 - j \\ 1 + j\end{matrix} ] \qquad ( 42 )$$

the QUBO problem solver service 230-2 computes the following QUBO matrix:

$${Q}_{3} = [ \begin{matrix}2.74 & 0 & - 1.58 & 0 \\ 0 & - 2.6 & 0 & 0.13 \\ - 1.58 & 0 & 0.43 & 0 \\ 0 & 0.13 & 0 & 1.58\end{matrix} ] \qquad ( 43 )$$

The values of the QUBO matrix are mapped onto the first plurality of synapses 335-1, 335-2, 335-3, 335-4 and of the second plurality of synapses 340-1, 340-2, 345-1, 345-2 as discussed above. Diagram 1060 of FIG. 10E illustrates operation of the neural network 300 using a set of tuning parameters that are shown in chart 1065. Plot 1070 illustrates the spiking of various neurons of the neural network 300. The neurons 310-3 and 310-4 spike at a rate greater than a threshold value, while the neurons 310-1, 310-2 do not spike at such a rate. The QUBO problem solver service 230-2 determines the values of the binary decision variables: [q₁, q₂, q₃, q₄]=[0, 0, 1, 1]. Using the determined values of the binary decision variables, the symbol vector detected is:

$$s = [ \begin{matrix}( 0 - 1 ) + j ( 0 - 1 ) \\ ( 2 - 1 ) + j ( 2 - 1 )\end{matrix} ] = [ \begin{matrix}- 1 - j \\ 1 + j\end{matrix} ] \qquad ( 44 )$$

For the following value of the symbol vector s and assuming that 11=0:

$$s = [ \begin{matrix}- 1 + j \\ 1 - j\end{matrix} ] \qquad ( 45 )$$

the QUBO problem solver service 230-2 computes the following QUBO matrix:

$${Q}_{4} = [ \begin{matrix}0.98 & 0 & - 1.58 & 0 \\ 0 & - 1.56 & 0 & 0.13 \\ - 1.58 & 0 & 0.99 & 0 \\ 0 & 0.13 & 0 & 1.93\end{matrix} ] \qquad ( 46 )$$

The values of the QUBO matrix are mapped onto the first plurality of synapses 335-1, 335-2, 335-3, 335-4 and of the second plurality of synapses 340-1, 340-2, 345-1, 345-2 as discussed above. Diagram 1075 of FIG. 10F illustrates operation of the neural network 300 using a set of tuning parameters that are shown in chart 1080. Plot 1085 illustrates the spiking of various neurons of the neural network 300. The neurons 310-2 and 310-3 spike at a rate greater than a threshold value, while the neurons 310-1, 310-4 do not spike at such a rate. The QUBO problem solver service 230-2 determines the values of the binary decision variables: [q₁, q₂, q₃, q₄]=[0, 1, 1, 0]. Using the determined values of the binary decision variables, the symbol vector detected is:

$$s = [ \begin{matrix}( 0 - 1 ) + j ( 0 - 1 ) \\ ( 2 - 1 ) + j ( 2 - 1 )\end{matrix} ] = [ \begin{matrix}- 1 - j \\ 1 + j\end{matrix} ] \qquad ( 47 )$$

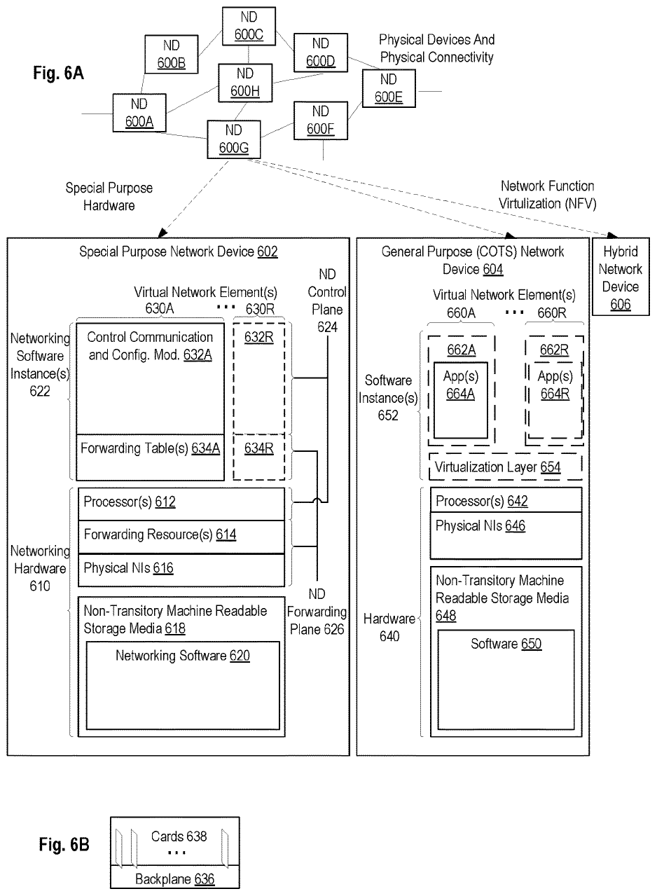

FIG. 5 is a diagram 500 illustrating exemplary neuromorphic hardware 220 (representing an instance of the neuromorphic hardware 220-1, 220-2), according to one or more embodiments. The features illustrated in the diagram 500 may be used in conjunction with other embodiments. For example, the diagram 500 may represent an exemplary architecture of the electronic devices 202-1, 202-2 of FIG. 2.

In the diagram 500, the neuromorphic hardware 220 comprises a plurality of neuromorphic cores 505-1, . . . , 505-4. Although four (4) neuromorphic cores 505 are depicted, any alternate number of neuromorphic cores 505 are also contemplated (e.g., hundreds or thousands of cores, or more). Each neuromorphic core 505 comprises a plurality of neurons, a plurality of synapses, and a communication interface. The communication interfaces of the neuromorphic cores 505-1, . . . , 505-4 are interconnected with each other using buses 510.

The host CPU 215 (representing an instance of the host CPUs 215-1, 215-2) and the machine-readable media 225 are included in a host printed circuit board assembly (PCBA) 520. As shown, the host PCBA 520 is shown as separate from the neuromorphic hardware 220 and connected using an interconnect 530 having any suitable implementation, such as Peripheral Component Interface Express (PCIe), Ethernet, and so forth. The host CPU 215 comprises a plurality of processor cores 515-1, . . . , 515-n that are connected to the machine-readable media 225 using a bus 525 having any suitable implementation.

In some embodiments, the host CPU 215 executes computer code including the QUBO problem solver service 230 to perform various functionality described herein. In some embodiments, the QUBO problem solver service 230 uses application programming interfaces (APIs) 545 and compilers 540 to program a spiking neural network architecture onto the neuromorphic hardware 220, e.g., according to the edge user allocations determined by the QUBO problem solver service 230. In some embodiments, the host CPU 215 also executes computer coder including a runtime 535 that provides low-level and system-level management functions.

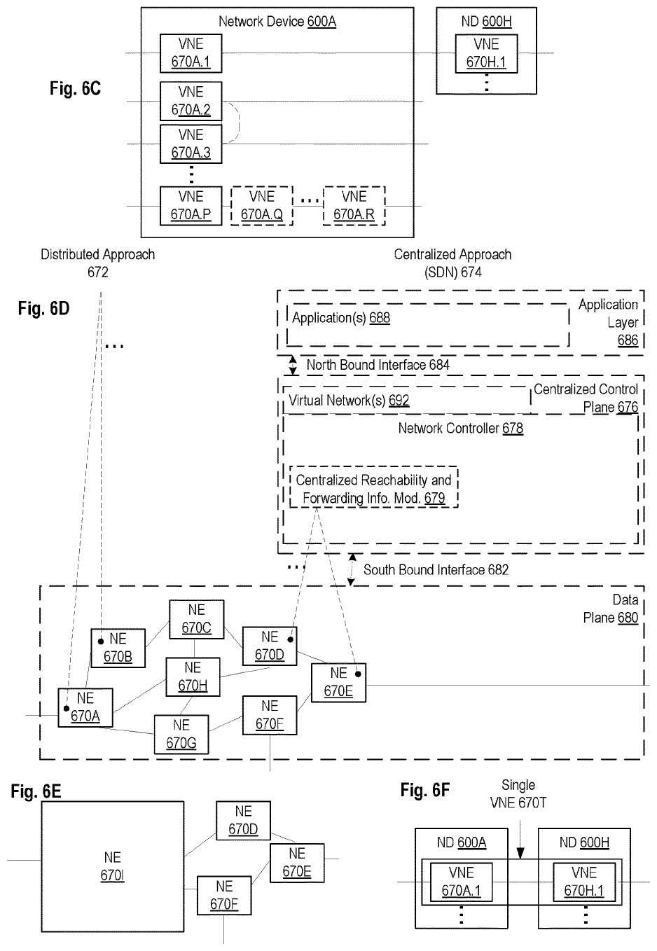

Refer now to FIG. 6A, which illustrates connectivity between network devices (NDs) within an exemplary network, as well as three exemplary implementations of the NDs, according to some embodiments of the invention. The features illustrated in FIG. 6A may be used in conjunction with other embodiments described herein. For example, some or all of the network devices 600A, . . . , 600-H may be examples of the electronic devices 202-1, 202-2 of FIG. 2, including a QUBO problem solver service 230-1, 230-2 and/or neuromorphic hardware 220-1, 220-2. As used herein, a network device is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general-purpose network device 604 that uses common off-the-shelf (COTS) processors and a standard OS.

The special-purpose network device 602 includes networking hardware 610 comprising a set of one or more processor(s) 612 (e.g., one example of the one or more processors 210-1, 210-2, which in some cases includes neuromorphic hardware 220-1, 220-2), forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A). In some embodiments, the functionality of the QUBO problem solver service 230-1, 230-2 may be included in the software 650. In other embodiments, the QUBO problem solver service 230-1, 230-2 may be implemented separate from the software 650 within the non-transitory machine readable storage media 648.

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general-purpose network device 604 includes hardware 640 comprising a set of one or more processor(s) 642 (which are often COTS processors) (e.g., another example of the one or more processors 210-1, 210-2, which in some cases includes neuromorphic hardware 220-1, 220-2) and physical NIs 646, as well as non-transitory machine-readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R-e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 6C illustrates various exemplary ways in which VNEs may be coupled according to some embodiments of the invention. FIG. 6C shows VNEs 670A.1-670A.P (and optionally VNEs 670A.Q-670A.R) implemented in ND 600A and VNE 670H.1 in ND 600H. In FIG. 6C, VNEs 670A.1-P are separate from each other in the sense that they can receive packets from outside ND 600A and forward packets outside of ND 600A; VNE 670A.1 is coupled with VNE 670H.1, and thus they communicate packets between their respective NDs; VNE 670A.2-670A.3 may optionally forward packets between themselves without forwarding them outside of the ND 600A; and VNE 670A.P may optionally be the first in a chain of VNEs that includes VNE 670A.Q followed by VNE 670A.R (this is sometimes referred to as dynamic service chaining, where each of the VNEs in the series of VNEs provides a different service—e.g., one or more layer 4-7 network services). While FIG. 6C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 6A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 6A may also host one or more such servers (e.g., in the case of the general purpose network device 604, one or more of the software instances 662A-R may operate as servers; the same would be true for the hybrid network device 606; in the case of the special-purpose network device 602, one or more such servers could also be run on a virtualization layer executed by the processor(s) 612); in which case the servers are said to be co-located with the VNEs of that ND.

A virtual network is a logical abstraction of a physical network (such as that in FIG. 6A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 6D illustrates a network with a single network element on each of the NDs of FIG. 6A, and within this straight forward approach contrasts a traditional distributed approach (commonly used by traditional routers) with a centralized approach for maintaining reachability and forwarding information (also called network control), according to some embodiments of the invention. Specifically, FIG. 6D illustrates network elements (NEs) 670A-H with the same connectivity as the NDs 600A-H of FIG. 6A.

FIG. 6D illustrates that the distributed approach 672 distributes responsibility for generating the reachability and forwarding information across the NEs 670A-H; in other words, the process of neighbor discovery and topology discovery is distributed.

For example, where the special-purpose network device 602 is used, the control communication and configuration module(s) 632A-R of the ND control plane 624 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 670A-H (e.g., the processor(s) 612 executing the control communication and configuration module(s) 632A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 624. The ND control plane 624 programs the ND forwarding plane 626 with information (e.g., adjacency and route information) based on the routing structure(s). For example, the ND control plane 624 programs the adjacency and route information into one or more forwarding table(s) 634A-R (e.g., Forwarding Information Base (FIB), Label Forwarding Information Base (LFIB), and one or more adjacency structures) on the ND forwarding plane 626. For layer 2 forwarding, the ND can store one or more bridging tables that are used to forward data based on the layer 2 information in that data. While the above example uses the special-purpose network device 602, the same distributed approach 672 can be implemented on the general purpose network device 604 and the hybrid network device 606.

FIG. 6D illustrates that a centralized approach 674 (also known as software defined networking (SDN)) that decouples the system that makes decisions about where traffic is sent from the underlying systems that forwards traffic to the selected destination. The illustrated centralized approach 674 has the responsibility for the generation of reachability and forwarding information in a centralized control plane 676 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 676 has a south bound interface 682 with a data plane 680 (sometime referred to the infrastructure layer, network forwarding plane, or forwarding plane (which should not be confused with a ND forwarding plane)) that includes the NEs 670A-H (sometimes referred to as switches, forwarding elements, data plane elements, or nodes). The centralized control plane 676 includes a network controller 678, which includes a centralized reachability and forwarding information module 679 that determines the reachability within the network and distributes the forwarding information to the NEs 670A-H of the data plane 680 over the south bound interface 682 (which may use the OpenFlow protocol). Thus, the network intelligence is centralized in the centralized control plane 676 executing on electronic devices that are typically separate from the NDs.

For example, where the special-purpose network device 602 is used in the data plane 680, each of the control communication and configuration module(s) 632A-R of the ND control plane 624 typically include a control agent that provides the VNE side of the south bound interface 682. In this case, the ND control plane 624 (the processor(s) 612 executing the control communication and configuration module(s) 632A-R) performs its responsibility for participating in controlling how data (e.g., packets) is to be routed (e.g., the next hop for the data and the outgoing physical NI for that data) through the control agent communicating with the centralized control plane 676 to receive the forwarding information (and in some cases, the reachability information) from the centralized reachability and forwarding information module 679 (it should be understood that in some embodiments of the invention, the control communication and configuration module(s) 632A-R, in addition to communicating with the centralized control plane 676, may also play some role in determining reachability and/or calculating forwarding information albeit less so than in the case of a distributed approach; such embodiments are generally considered to fall under the centralized approach 674, but may also be considered a hybrid approach).

While the above example uses the special-purpose network device 602, the same centralized approach 674 can be implemented with the general purpose network device 604 (e.g., each of the VNE 660A-R performs its responsibility for controlling how data (e.g., packets) is to be routed (e.g., the next hop for the data and the outgoing physical NI for that data) by communicating with the centralized control plane 676 to receive the forwarding information (and in some cases, the reachability information) from the centralized reachability and forwarding information module 679; it should be understood that in some embodiments of the invention, the VNEs 660A-R, in addition to communicating with the centralized control plane 676, may also play some role in determining reachability and/or calculating forwarding information albeit less so than in the case of a distributed approach) and the hybrid network device 606. In fact, the use of SDN techniques can enhance the NFV techniques typically used in the general-purpose network device 604 or hybrid network device 606 implementations as NFV is able to support SDN by providing an infrastructure upon which the SDN software can be run, and NFV and SDN both aim to make use of commodity server hardware and physical switches.

FIG. 6D also shows that the centralized control plane 676 has a north bound interface 684 to an application layer 686, in which resides application(s) 688. The centralized control plane 676 has the ability to form virtual networks 692 (sometimes referred to as a logical forwarding plane, network services, or overlay networks (with the NEs 670A-H of the data plane 680 being the underlay network)) for the application(s) 688. Thus, the centralized control plane 676 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 6D shows the distributed approach 672 separate from the centralized approach 674, the effort of network control may be distributed differently or the two combined in certain embodiments of the invention. For example: 1) embodiments may generally use the centralized approach (SDN) 674, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 674, but may also be considered a hybrid approach.

While FIG. 6D illustrates the simple case where each of the NDs 600A-H implements a single NE 670A-H, it should be understood that the network control approaches described with reference to FIG. 6D also work for networks where one or more of the NDs 600A-H implement multiple VNEs (e.g., VNEs 630A-R, VNEs 660A-R, those in the hybrid network device 606). Alternatively or in addition, the network controller 678 may also emulate the implementation of multiple VNEs in a single ND. Specifically, instead of (or in addition to) implementing multiple VNEs in a single ND, the network controller 678 may present the implementation of a VNE/NE in a single ND as multiple VNEs in the virtual networks 692 (all in the same one of the virtual network(s) 692, each in different ones of the virtual network(s) 692, or some combination). For example, the network controller 678 may cause an ND to implement a single VNE (a NE) in the underlay network, and then logically divide up the resources of that NE within the centralized control plane 676 to present different VNEs in the virtual network(s) 692 (where these different VNEs in the overlay networks are sharing the resources of the single VNE/NE implementation on the ND in the underlay network).

On the other hand, FIGS. 6E and 6F respectively illustrate exemplary abstractions of NEs and VNEs that the network controller 678 may present as part of different ones of the virtual networks 692. FIG. 6E illustrates the simple case of where each of the NDs 600A-H implements a single NE 670A-H (see FIG. 6D), but the centralized control plane 676 has abstracted multiple of the NEs in different NDs (the NEs 670A-C and G-H) into (to represent) a single NE 670I in one of the virtual network(s) 692 of FIG. 6D, according to some embodiments of the invention. FIG. 6E shows that in this virtual network, the NE 670I is coupled to NE 670D and 670F, which are both still coupled to NE 670E.

FIG. 6F illustrates a case where multiple VNEs (VNE 670A.1 and VNE 670H.1) are implemented on different NDs (ND 600A and ND 600H) and are coupled to each other, and where the centralized control plane 676 has abstracted these multiple VNEs such that they appear as a single VNE 670T within one of the virtual networks 692 of FIG. 6D, according to some embodiments of the invention. Thus, the abstraction of a NE or VNE can span multiple NDs.

While some embodiments of the invention implement the centralized control plane 676 as a single entity (e.g., a single instance of software running on a single electronic device), alternative embodiments may spread the functionality across multiple entities for redundancy and/or scalability purposes (e.g., multiple instances of software running on different electronic devices).

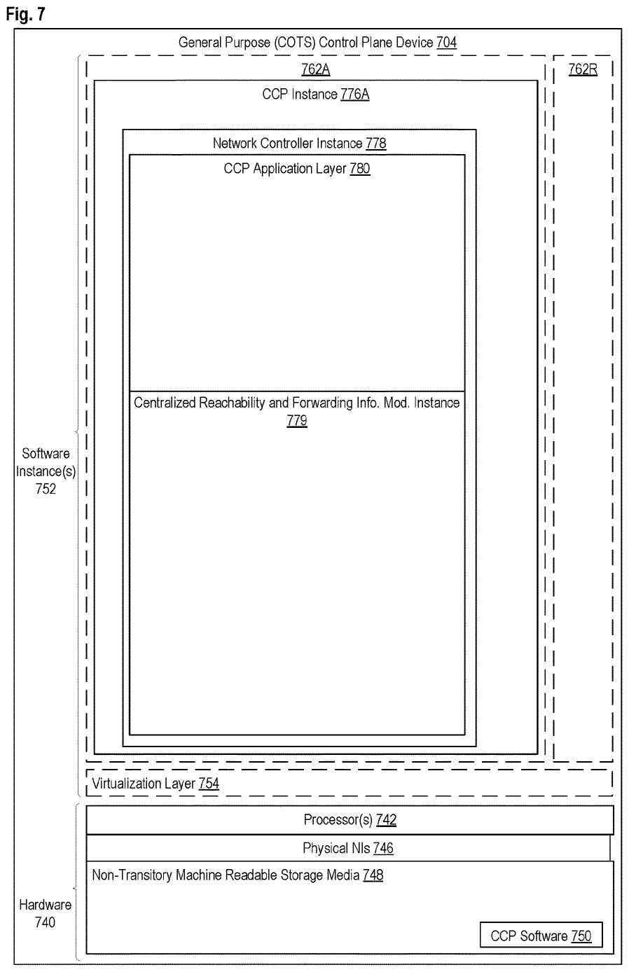

Similar to the network device implementations, the electronic device(s) running the centralized control plane 676, and thus the network controller 678 including the centralized reachability and forwarding information module 679, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 7 illustrates, a general-purpose control plane device 704 including hardware 740 comprising a set of one or more processor(s) 742 (which are often COTS processors) and physical NIs 746, as well as non-transitory machine-readable storage media 748 having stored therein centralized control plane (CCP) software 750.

In embodiments that use compute virtualization, the processor(s) 742 typically execute software to instantiate a virtualization layer 754 (e.g., in one embodiment the virtualization layer 754 represents the kernel of an operating system (or a shim executing on a base operating system) that allows for the creation of multiple instances 762A-R called software containers (representing separate user spaces and also called virtualization engines, virtual private servers, or jails) that may each be used to execute a set of one or more applications; in another embodiment the virtualization layer 754 represents a hypervisor (sometimes referred to as a virtual machine monitor (VMM)) or a hypervisor executing on top of a host operating system, and an application is run on top of a guest operating system within an instance 762A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 740, directly on a hypervisor represented by virtualization layer 754 (in which case the unikernel is sometimes described as running within a LibOS virtual machine), or in a software container represented by one of instances 762A-R). Again, in embodiments where compute virtualization is used, during operation an instance of the CCP software 750 (illustrated as CCP instance 776A) is executed (e.g., within the instance 762A) on the virtualization layer 754. In embodiments where compute virtualization is not used, the CCP instance 776A is executed, as a unikernel or on top of a host operating system, on the “bare metal” general purpose control plane device 704. The instantiation of the CCP instance 776A, as well as the virtualization layer 754 and instances 762A-R if implemented, are collectively referred to as software instance(s) 752.

In some embodiments, the CCP instance 776A includes a network controller instance 778. The network controller instance 778 includes a centralized reachability and forwarding information module instance 779 (which is a middleware layer providing the context of the network controller 678 to the operating system and communicating with the various NEs), and an CCP application layer 780 (sometimes referred to as an application layer) over the middleware layer (providing the intelligence required for various network operations such as protocols, network situational awareness, and user-interfaces). At a more abstract level, this CCP application layer 780 within the centralized control plane 676 works with virtual network view(s) (logical view(s) of the network) and the middleware layer provides the conversion from the virtual networks to the physical view.

The centralized control plane 676 transmits relevant messages to the data plane 680 based on CCP application layer 780 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 7 or more) in the packet headers. Different NDs/NEs/VNEs of the data plane 680 may receive different messages, and thus different forwarding information. The data plane 680 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 680, the packet (or a subset of the packet header and content) is typically forwarded to the centralized control plane 676. The centralized control plane 676 will then program forwarding table entries into the data plane 680 to accommodate packets belonging to the flow of the unknown packet. Once a specific forwarding table entry has been programmed into the data plane 680 by the centralized control plane 676, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path-multiple equal cost next hops), some additional criteria is used for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VOD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

The neural network-based implementations described herein enable rapid, energy-efficient solutions to NP-complete and/or NP-hard problems that may be framed as QUBO problems, as well as applications thereof. As discussed above, various optimization calculations may be performed to improve the performance of mobile networks and/or electronic devices encompassed thereby.

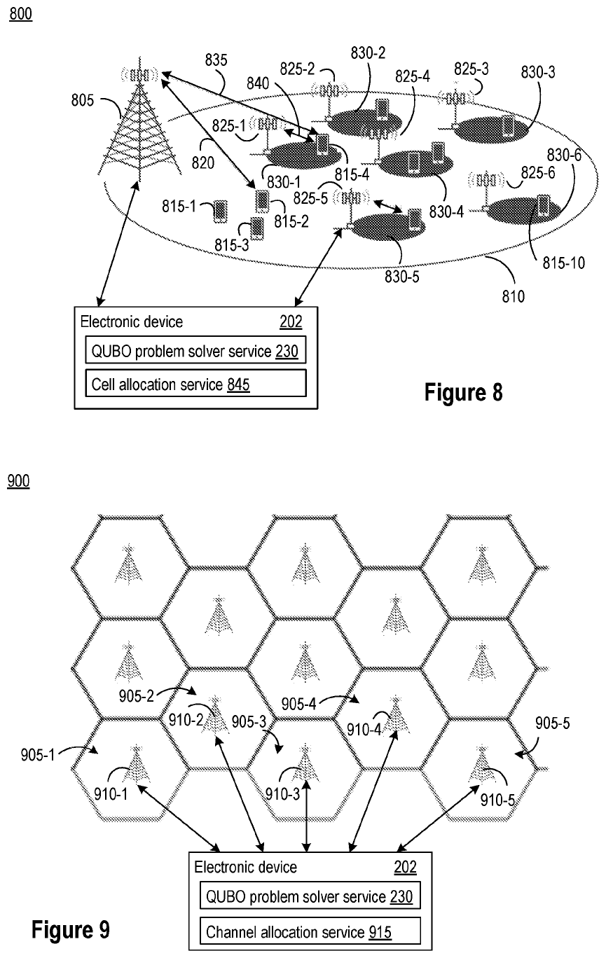

FIG. 8 illustrates an exemplary application of the neural network-based implementations to an example cell allocation for a mobile network 800, according to one or more embodiments. The mobile network 800 is depicted in a simplified form for the sake of illustration. The person of ordinary skill in the art will appreciate that the mobile network 800 may include numerous additional electronic devices, functions, and components that would be involved in the operation of the mobile network 800. The mobile network 800 can implement any communication technology such as 3G, 4G, 5G (e.g., as defined by 3GPP) technologies or similar technologies.

The mobile network 800 comprises a plurality of RAN base stations 805, 825-1, 825-2, . . . , 825-6 that can enable wireless connections with a number of mobile devices 815-1, 815-3, . . . , 815-10 (generically or collectively, mobile device(s) 815) that use the services of the mobile network 800. Each RAN base station 805, 825-1, 825-2, . . . , 825-6 represents a respective “cell” 810, 830-1, 830-2, . . . , 830-6 of the mobile network 800 and has a respective coverage area.

As shown, the RAN base station 805 corresponds to a first cell 810 of the mobile network 800, and the RAN base stations 825-1, 825-2, . . . , 825-6 correspond to second cells 830-1, 830-2, . . . , 830-6 of the mobile network 800. The second cells 830-1, 830-2, . . . , 830-6 are smaller than, and overlapping with, the first cell 810. For example, the first cell 810 represents a “macrocell” of the mobile network 800 and the second cells 830-1, 830-2, . . . , 830-6 represent “small cells” of the mobile network 800, such as “microcells”, “picocells”, and/or “femtocells”. The RAN base stations 825-1, 825-2, . . . , 825-6 may have different characteristics and/or different deployments to improve the overall capacity of the mobile network 800. For example, the RAN base station 805 may be mounted on a large tower (or transmitter mast) to provide multiple miles of coverage for the mobile devices 815, e.g., suitable for large towns, rural areas, and so forth. The RAN base stations 825-1, 825-2, . . . , 825-6 typically have smaller, low-power implementations with lesser range, and may be mounted on smaller towers or other outdoor and/or indoor locations, e.g., suitable for urban environments.

The RAN base stations 805, 825-1, 825-2, . . . , 825-6 may be connected with each other and with one or more other electronic devices providing infrastructure of the mobile network 800, e.g., using wireline connections. In some embodiments, the electronic device 202 is connected with the RAN base stations 805, 825-1, 825-2, . . . , 825-6 and includes a cell allocation service 845 representing code that is executed by the one or more processors 210-1, 210-2 to allocate the RAN base stations 805, 825-1, 825-2, . . . , 825-6 to service each of the mobile devices 815.

The mobile devices 815 are expected to transit various ones of the cells 810, 830-1, 830-2, . . . , 830-6. Thus, the mobile devices 815 at times may located within multiple cells 810, 830-1, 830-2, . . . , 830-6. For example, each of the mobile devices 815 is located in the first cell 810 (e.g., the macrocell), and some of the mobile devices 815 are also located in a respective one of the second cells 830-1, 830-2, . . . , 830-6. Thus, determining which RAN base station 805, 825-1, 825-2, . . . , 825-6 to allocate to a particular mobile device 815 at a particular time may be framed as an optimization problem, e.g., to improve a throughput and/or a quality of service of the mobile network 800. For example, the optimization problem maximizes the system rate of mobile devices 815 associated with a cell with a minimum number of base stations, such that each mobile device 815 is served by one cell, and the number of mobile devices 815 served by a cell is bound by the available throughput of the base station of the cell. In some embodiments, the electronic device 202 comprises the QUBO problem solver service 230, and the solution generated by the QUBO problem solver service 230 is provided to the cell allocation service 845.

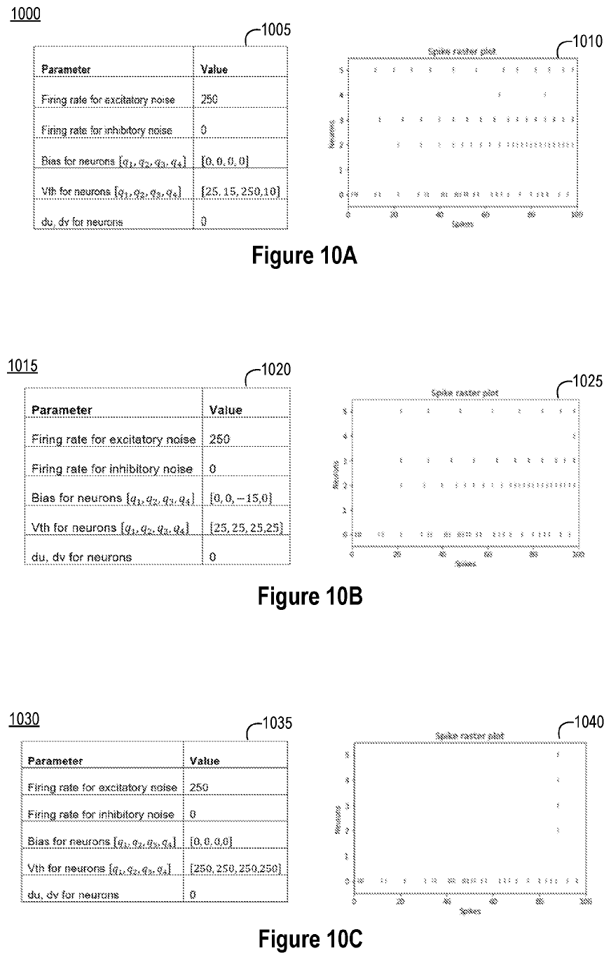

FIG. 9 illustrates an exemplary application of the neural network-based implementations to an example channel allocation for a mobile network 900, according to one or more embodiments. The mobile network 900 is depicted in a simplified form for the sake of illustration. The person of ordinary skill in the art will appreciate that the mobile network 900 may include numerous additional electronic devices, functions, and components that would be involved in the operation of the mobile network 900. The mobile network 900 can implement any communication technology such as 3G, 4G, 5G (e.g., as defined by 3GPP) technologies or similar technologies.

The mobile network 900 comprises a plurality of RAN base stations 910-1, 910-2, 910-5 representing respective “cells” 905-1, 905-2, . . . , 905-5. The RAN base stations 910-1, 910-2, . . . , 910-5 may be connected with each other and with one or more other electronic devices providing infrastructure of the mobile network 900, e.g., using wireline connections. In some embodiments, the electronic device 202 is connected with the RAN base stations 910-1, 910-2, . . . , 910-5 and includes a channel allocation service 915 representing code that is executed by the processor(s) of the electronic device 202 to allocate bandwidth and/or channels to each of the RAN base stations 910-1, 910-2, . . . , 910-5 for servicing mobile devices encompassed by the mobile network 900.

Determining which bandwidth and/or channels to allocate to a particular RAN base station 910-1, 910-2, . . . , 910-5 at a particular time may be framed as an optimization problem, e.g., to improve a throughput and/or a quality of service of the mobile network 900. For example, in the frequency domain, the entire available bandwidth is divided into smaller chunks comprised of many subcarriers. In the time domain, a frame-based division is defined which is composed of many sub-frames with each time length equivalent to one Transmission Time Interval (TTI). The minimum resource allocation unit that can be assigned is called a Scheduling Unit (SU), and the base station schedules units of Time-Frequency resources among the active mobile devices within the cell once per TTI, typically at the beginning of the interval.

The objective of the optimization problem is to maximize the quality of service experienced by all the mobile devices by distributing the finite number of radio resources among them, such that one mobile device is served per scheduling unit and single modulation and coding scheme is adapted over all the resources assigned to a given mobile device. In some embodiments, the electronic device 202 comprises the QUBO problem solver service 230, and the solution generated by the QUBO problem solver service 230 is provided to the channel allocation service 915.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by an electronic device for solving a quadratic unconstrained binary optimization problem, the method comprising:
implementing a plurality of neurons, each neuron representing a respective binary decision variable of the QUBO problem, each neuron connected to one or both of a respective excitatory noise source and a respective inhibitory noise source;
implementing a first plurality of synapses as a plurality of recurrent synapses, each recurrent synapse connected to a respective neuron of the plurality of neurons, each recurrent synapse having a respective weight corresponding to a diagonal coefficient of a QUBO matrix; and
implementing a second plurality of synapses as a plurality of lateral synapses extending between pairs of neurons of the plurality of neurons, each lateral synapse having a respective weight corresponding to an off-diagonal coefficient of the QUBO matrix.

2. The method of claim 1, wherein for each synapse of the first plurality of synapses and of the second plurality of synapses:
the synapse is implemented as an excitatory synapse-when the corresponding coefficient of the QUBO matrix has a negative sign; and
the synapse is implemented as an inhibitory synapse when the corresponding coefficient of the QUBO matrix has a positive sign.

3. The method claim 1, wherein each excitatory noise source and each inhibitory noise source generates Poisson noise.

4. The method of claim 1, wherein the electronic device is a multiple-input multiple-output-capable communication device comprising one or more antennae, the method further comprising:
receiving a first symbol vector using the one or more antennae; and
computing the QUBO matrix using the first symbol vector and a channel matrix.

5. The method of claim 4, further comprising:
receiving a second symbol vector using the one or more antennae; and
decoding, using the plurality of neurons, the second symbol vector into a plurality of signals.

6. The method of claim 4, wherein the one or more antennae comprise a plurality of antennae.

7. The method of claim 1, wherein the electronic device is included in a mobile network, the method further comprising:
determining an allocation of a plurality of mobile devices among: a first base station of a first cell of the mobile network, and one or more second base stations of one or more second cells of the mobile network, the one or more second cells smaller than, and overlapping with, the first cell.

8. The method of claim 1, wherein the electronic device is included in a mobile network, the method further comprising:
determining an allocation of a plurality of channels among a plurality of base stations of a plurality of cells of the mobile network.

9. A non-transitory machine-readable storage medium comprising computer program code which, when executed by a computer for solving a quadratic unconstrained binary optimization problem, cause the computer to perform operations comprising:
implementing a plurality of neurons, each neuron representing a respective binary decision variable of the QUBO problem, each neuron connected to one or both of a respective excitatory noise source and a respective inhibitory noise source;
implementing a first plurality of synapses as a plurality of recurrent synapses, each recurrent synapse connected to a respective neuron of the plurality of neurons, each recurrent synapse having a respective weight corresponding to a diagonal coefficient of a QUBO matrix; and
implementing a second plurality of synapses as a plurality of lateral synapses extending between pairs of neurons of the plurality of neurons, each lateral synapse having a respective weight corresponding to an off-diagonal coefficient of the QUBO matrix.

10. An electronic device comprising:
a machine-readable medium comprising computer program code for a quadratic unconstrained binary optimization problem solver service to solve a QUBO problem; and
one or more processors to execute the QUBO problem solver service to cause the electronic device to implement:
a plurality of neurons, each neuron representing a respective binary decision variable of the QUBO problem;
a plurality of excitatory noise sources, each neuron connected to a respective excitatory noise source;
a first plurality of synapses as a plurality of recurrent synapses, each recurrent synapse connected to a respective neuron of the plurality of neurons, each recurrent synapse having a respective weight corresponding to a diagonal coefficient of a QUBO matrix; and
a second plurality of synapses as a plurality of lateral synapses extending between pairs of neurons of the plurality of neurons, each lateral synapse having a respective weight corresponding to an off-diagonal coefficient of the QUBO matrix.

11. The electronic device of claim 10, wherein the QUBO problem solver service causes the electronic device to further implement:
a plurality of inhibitory noise sources, each neuron connected to a respective inhibitory noise source.

12. The electronic device claim 10, wherein for each synapse of the first plurality of synapses and of the second plurality of synapses:
the synapse is implemented as an excitatory synapse when the corresponding coefficient of the QUBO matrix has a negative sign; and
the synapse is implemented as an inhibitory synapse when the corresponding coefficient of the QUBO matrix has a positive sign.

13. The electronic device of claim 10, wherein each excitatory noise source and each inhibitory noise source generates Poisson noise.

14. The electronic device of claim 10, wherein the electronic device is a multiple-input multiple-output-capable communication device, the electronic device further comprising:
one or more antennae, wherein the one or more processors further to:
receive a first symbol vector using the one or more antennae; and
compute the QUBO matrix using the first symbol vector and a channel matrix.

15. The electronic device of claim 14, the one or more processors further to:
receive a second symbol vector using the one or more antennae; and
decode, using the plurality of neurons, the second symbol vector into a plurality of signals.

16. The electronic device of claim 14, wherein the one or more antennae comprise a plurality of antennae.

17. The electronic device of claim 10, wherein the electronic device is included in a mobile network, the one or more processors further to:
determine an allocation of a plurality of mobile devices among: a first base station of a first cell-of the mobile network, and one or more second base stations of one or more second cells of the mobile network, the one or more second cells smaller than, and overlapping with, the first cell.

18. The electronic device of claim 10, wherein the electronic device is included in a mobile network, the one or more processors further to:
determine an allocation of a plurality of channels among a plurality of base stations of a plurality of cells of the mobile network.

19. The electronic device of claim 11, wherein the one or more processors comprise neuromorphic hardware that the QUBO problem solver service configures to cause the electronic device to implement at least the plurality of neurons, the plurality of excitatory noise sources, the plurality of inhibitory noise sources, the first plurality of synapses, and the second plurality of synapses.
